(19) United States
(12) Patent Application Publication
(10) Pub. No.: US 2001/0055379 A1
(43) Pub. Date: Dec. 27, 2001

(54) Communication service information providing system

(75) Inventors: Keiko Mamiya, Kawasaki (JP); Hiroyo Masuda, Kawasaki (JP)

Correspondence Address: HELFGOTT & KARAS, P.C., 60th Floor, Empire State Building, New York, NY, 10118, US

(73) Assignee: FUJITSU LIMITED

(21) Appl. No.: 09/760,580

(22) Filed: Jan. 16, 2001

(30) Foreign Application Priority Data
May 19, 2000 (JP) 2000-148526

(51) Int. Cl. H04M 3/42; H04M 7/00

(52) U.S. Cl. 379/201.05; 379/219; 379/221.05

(57) ABSTRACT

A communication service information providing method is comprised the step of storing both a plurality of communication services which are subscribed to by a subscriber and are made of plural sorts of information representation media, and identification information capable of selectively utilizing the communication services so as to establish a communication, and the step of notifying both the communication service subscribed to by a subscriber that wants to establish a communication, and the identification information corresponding to the communication service to a calling terminal in response to a request issued from the calling terminal. With employment of this structural step, it can acquire and/or confirm both the communication service subscribed to by the subscriber of the communication counter party and the identification information, or the identifier corresponding to this communication service.

### BACKGROUND OF THE INVENTION

The present invention generally relates to a communication service providing system for storing a single type terminal, or a composite type terminal, which are subscribed to receive various sorts of communication services. More specifically, the present invention is directed to such a communication service information providing method capable of acquiring and/or confirming a communication service subscribed to by a communication counter party, and also identification information (identifier) corresponding to this communication service.

Furthermore, the present invention is related to such a method capable of particularly achieving a validity of a multimedia communication terminal made from a single terminal body, or a composite terminal body, which can use in conjunction with a circuit switching mode bearer and also a plurality of bearers contained in a packet switching mode bearer.

In a conventional multimedia information communication system, plural sorts of services can be provided with respect to a fixed communication terminal (ISDN-adaptive telephone terminal) and a mobile communication terminal, which function as a multimedia terminal. These plural sorts of services are involved in communication services (will be simply referred to as “services” hereinafter) such as a speech (voice) communication, a speech-added communication, a short message communication, and a data communication.

In particular, in the case that the multimedia terminal corresponds to a multimedia mobile communication terminal, terminal users (subscribers) may receive multimedia information communication services via the above-explained communication services without any restrictions caused by differences in various wireless environments and regional locations, while effectively utilizing personality (moving subscriber characteristics) and mobility (moving characteristics), which may constitute merits of mobile communication terminals. These wireless environments imply indoor locations, outdoor locations, walking speeds, high-speed moving speeds, and the like. The regional location simply countries, cities, suburbs, and the like.

In other words, these terminal users may transmit/receive information representation media (speech, data, character, figure, still image, and moving picture etc.) to/from arbitrarily selected counter parties, while these information representation media and qualities (transfer speed etc.) are arbitrarily combined with each other.

For instance, when a multimedia terminal is a so-called “i-mode”-adaptive portable telephone terminal, or a multimedia mobile communication terminal constructed of a composite terminal body, both a telephone number and an electronic mail address are set as subscriber identification information (identifier) for every service. The above-explained “i-mode”-adaptive portable telephone terminal is constructed of a single terminal body capable of transmitting/receiving not only speech but also characters as information representation media. The multimedia mobile communication terminal is an EZ access/EZ Web-adaptive portable telephone terminal operated on the basis of the WAP (Wireless Application Protocol) protocol and made of a single terminal body. The composite-body-type multimedia mobile communication terminal is integrally arranged by such a portable telephone terminal subscribing to a speech communication service, and a notebook type personal computer (PC) connected to this portable telephone terminal.

As a consequence, when a user of this multimedia mobile communication terminal does not know a subscriber identifier of such a multimedia mobile communication terminal owned by a communication counter party, or a subscriber identifier of a multimedia fixed communication terminal owned by the communication counter party, this user cannot designate the available service thereof to access. In other word, in such a case that this user establishes a speech communication (telephone communication) with respect to a terminal of a communication counter party, only that telephone number is known, and further this user encounters with a busy state of this communication counter party, this user cannot send any electronic mail to the terminal of the counter party unless an electronic mail address of this counter party is grasped. Also, there is no such an automatic confirmation method with which capable of confirming whether or not a terminal of a communication counter party can receive an electronic mail.

### SUMMARY OF THE INVENTION

Therefore, an object of the present invention is to provide both a communication service information providing method and a communication network, capable of acquiring or confirming both a communication service subscribed to by a communication counter party and identification information (identifier) corresponding to this communication service, with respect to a calling (originating) terminal.

Another object of the present invention is to provide both a communication service information providing method and a communication network, capable of conducting a new communication service, without applying any specific change in the existing communication terminal made of a single terminal body or a composite terminal body.

A further object of the present invention is to provide both a communication service information providing method and a communication network, capable of particularly achieving validity in a multimedia communication terminal made of either a single terminal body or a composite terminal body, which can be used in conjunction with both a circuit switching mode bearer and a plurality of bearers contained in a packet switching mode bearer.

To attain the above-mentioned objects of the present invention, a communication service information providing method according to a first aspect of the present invention comprises the steps of:

receiving a call used to select one of plural communication services, which is transmitted from a calling subscriber to a called subscriber that subscribes the plurality of communication services; and

providing information related to another communication service subscribed to by the called subscriber with respect to the calling subscriber.

A communication service information providing method according to a second aspect of the present invention comprises the steps of:

receiving a call used to select one of plural communication services, which is transmitted from a calling subscriber to a called subscriber that subscribes the plurality of communication services;

providing information related to another communication service subscribed to by the called subscriber with respect to the calling subscriber; and

when the calling subscriber selects one of other communication services from the provided information, trying to connect to the called subscriber by way of the selected another communication service.

A communication service information providing method according to a third aspect of the present invention comprises the steps of:

receiving a call issued from a calling subscriber that selects a voice communication to a called subscriber, while utilizing a communication terminal equipped with a display unit;

acquiring communication identification information from a database related to the called subscriber in a switching apparatus which accepts the call, the communication identification information being any one of a telephone number, an electronic mail address, and a facsimile number of communication services which are subscribed to by the called subscriber; and

displaying the acquired communication identification information on the display unit of the communication terminal owned by the calling subscriber under a selectable condition.

A communication service information providing method according to a fourth aspect of the present invention comprises the steps of:

storing both a plurality of communication services which are subscribed to by a subscriber and are made of plural sorts of information representation media, and identification information capable of selectively utilizing the communication services so as to establish a communication; and

notifying both the communication service subscribed to by a subscriber that wants to establish a communication, and the identification information corresponding to the communication service to a calling terminal in response to a request issued from the calling terminal.

A communication service information providing method according to a fifth aspect of the present invention comprises:

storing both a plurality of communication services which are subscribed to by a subscriber and are made of plural sorts of information representation media, and identification information capable of selectively utilizing the communication services so as to establish a communication; and

notifying both the communication service subscribed to by a subscriber that wants to establish a communication, and the identification information corresponding to the communication service to a calling terminal when the calling terminal encounters with a communication non-connectable state.

A communication service information providing method according to a sixth aspect of the present invention further comprises the step of:

notifying to the calling terminal, both the communication service and the identification information corresponding to the communication service, in the form of an allowable mode which is previously registered by the subscriber to which wants to establish the communication.

A communication service information providing method according to a seventh aspect of the present invention further comprises the step of:

notifying to the calling terminal, both the communication service and the identification information corresponding to the communication service subscribed to by the subscriber that wants to establish the communication by way of the information representation media requested by the calling terminal.

A communication service information providing method according to an eighth aspect of the present invention further comprises the step of:

notifying to the calling terminal, both the communication service and the identification information corresponding to the communication service subscribed to by the subscriber that wants to establish the communication by way of the information representation media which is used to issue the call by the calling terminal.

A communication service information providing method according to a ninth aspect of the present invention further comprises the step of:

changing both the communication service and the identification information corresponding to the communication service, in the form of an allowable mode which is previously registered by the subscriber to which wants to establish the communication, in accordance with the calling terminal, and for notifying the changed communication service and the changed identification information.

A communication service information providing method according to a tenth aspect of the present invention further comprises the step of:

notifying an occurrence of a call reception to the subscriber that wants to establish the communication, and for notifying to the calling terminal, a substitution of both the communication service and the identification information corresponding to the communication service in accordance with a content of a response.

A communication service information providing method according to an eleventh aspect of the present invention further comprises the step of:

changing the selected communication service to the substitution of both the communication service and the identification information corresponding to the communication service, after agreeing by the subscriber that wants to establish the communication.

A communication service information providing method according to a twelfth aspect of the present invention comprises the steps of:

storing both a plurality of communication services which are subscribed to by a subscriber and are made of plural sorts of information representation media, and identification information by which the communication services can be selectively used to establish a communication; and

selecting both the communication service subscribed to by a subscriber that wants to establish a communication, and the identification information corresponding to the communication service, to which a calling terminal is communication-connectable in response to the communication condition of the information representation media, and for notifying the selected communication service and the selected identification information to the calling terminal.

A communication service information providing method according to a thirteenth aspect of the present invention further comprises the step of:

notifying the identification information which is temporarily allocated to the calling terminal.

A communication service information providing method according to a fourteenth aspect of the present invention further comprises the step of:

selectively notifying one of the identification information which is temporarily allocated, and the identification information under normal condition in response to the calling terminal.

A communication network according to a first aspect of the present invention comprises:

reception means for receiving a call used to select one of plural communication services from a calling terminal with respect to a subscriber of a communication counter party that wants to establish a communication and subscribes the plurality of communication services; and

providing means for providing information related to another communication service subscribed to by the subscriber of the communication counter party that wants to establish the communication with respect to the calling terminal.

A communication network according to a second aspect of the present invention comprises:

reception means for receiving a call used to select one of plural communication services from a calling terminal with respect to a subscriber of a communication counter party that wants to establish a communication and subscribes the plurality of communication services;

providing means for providing information related to another communication service subscribed to by the subscriber of the communication counter party that wants to establish the communication with respect to the calling terminal; and

connection means in which when the calling terminal selects one of other communication services from the provided information, the connection means tries to connect with the subscriber of the communication counter party that wants to establish the communication by using the selected another communication service.

A communication network according to a third aspect of the present invention comprises:

reception means for receiving a call issued to a subscriber of a communication counter party that wants to establish a communication from a communication terminal which equipped with a display unit and selected a voice communication;

acquisition means for acquiring communication identification information in a switching apparatus which accepts the call from a database related to the subscriber of the communication-desired counter party, the communication identification information being any one of a telephone number, an electronic mail address, and a facsimile number, which correspond to the subscriber of the communication-desired counter party; and

display process means for displaying the acquired communication identification information on the display unit of the communication terminal under selectable condition.

A communication network according to a fourth aspect of the present invention comprises:

storage means for storing both a plurality of communication services which are subscribed to by a subscriber and are made of plural sorts of information representation media, and identification information capable of selectively utilizing the communication services so as to establish a communication; and

notification means for notifying both the communication service subscribed to by a subscriber that wants to establish a communication, and the identification information corresponding to the communication service to a calling terminal in response to a request issued from the calling terminal.

A communication network according to a fifth aspect of the present invention comprises:

storage means for storing both a plurality of communication services which are subscribed to by a subscriber and are made of plural sorts of information representation media, and also identification information capable of selectively utilizing the communication services so as to establish a communication; and

notification means for notifying both the communication service subscribed to by a subscriber that wants to establish a communication, and the identification information corresponding to the communication service to a calling terminal when the calling terminal encounters with a communication non-connectable state.

A communication network according to a sixth aspect of the present invention comprises:

storage means for storing both a plurality of communication services which are subscribed to by a subscriber and are made of plural sorts of information representation media, and identification information by which the communication services can be selectively used to establish a communication; and

notification means for selecting both the communication service subscribed to by a subscriber that wants to establish a communication, and the identification information corresponding to the communication service, to which a calling terminal is communication-connectable in response to the communication condition of the information representation media, and for notifying the selected communication service and the selected identification information to the calling terminal.

According to the present invention, it enables the calling terminal to acquire and/or confirm both the communication service subscribed to by the subscriber of the communication counter party and the identification information, or the identifier corresponding to this communication service.

Further, according to the present invention, since the above-mentioned information communication service is allowed to provide on the side of the communication system (on the side of the communication network), capable of conducting a new communication service, without applying any specific change in the existing communication terminal made of a single terminal body or a composite terminal body.

In addition, according to the present invention, in a multimedia communication terminal made from a single terminal body, or a composite terminal body, which can use in conjunction with a circuit switching mode bearer and also a plurality of bearers contained in a packet switching mode bearer, the validity thereof can be particularly achieved.

### BRIEF DESCRIPTION OF THE DRAWINGS

The foregoing and other features and advantages of the present invention will become more readily appreciated as the same becomes better understood by reference to the following detailed description when taken into conjunction with the accompanying drawings wherein:

FIG. 1 is a schematic block diagram for representing a basic arrangement of a multimedia information communication system according to one embodiment of the present invention;

FIG. 2 is a schematic block diagram for representing a basic arrangement of a multimedia information communication system according to one embodiment of the present invention;

FIG. 3 is a schematic block diagram for showing a concrete arrangement of the multimedia information communication system according to one embodiment of the present invention;

FIG. 4 is a diagram for illustratively showing both a subscriber data structure and a data structure of an interrogation database;

FIG. 5 illustratively represents an operation example in the case that a service interrogation is made from a multimedia mobile communication terminal;

FIG. 6 illustratively represents an operation example in the case that a service interrogation is made from a fixed multimedia communication terminal;

FIG. 7 is a diagram for showing a format of a service interrogation message;

FIG. 8 is a diagram for indicating a format of a service interrogation message;

FIG. 9 illustratively shows an operation example in the case that a service is provided when a bussy state is detected;

FIG. 10 is a flow chart for describing operations of a home LOCATION register when a service interrogation request is received;

FIG. 11 is a flow chart for explaining operations of the home LOCATION register when a response message is edited;

FIG. 12 is a flow chart for describing operations of a switching unit when a busy state is detected;

FIG. 13 is a schematic diagram for indicating an example of a response message editing operation;

FIG. 14 represents a sequence chart when a service is registered;

FIG. 15 is a sequence chart when a service interrogation (talkie connection pattern);

FIG. 16 is a schematic diagram for showing a structural example in the case that a content of an interrogation response is an URL;

FIG. 17 is a sequence chart in the case that a content of an interrogation response is an URL;

FIG. 18 is a sequence chart in the case that a desirable response style is a talkie;

FIG. 19 is a schematic diagram for indicating an operation example in the case that the desirable response style is an electronic mail;

FIG. 20 is a sequence chart in the case that the desirable response style is the electronic mail;

FIG. 21 shows an operation sequence chart when a service is carried out;

FIG. 22 indicates an operation sequence chart when a service is carried out;

FIG. 23 represents an operation sequence chart when a service is carried out;

FIG. 24 shows an operation sequence chart when a service is carried out;

FIG. 25 represents an operation sequence chart when a service is carried out;

FIG. 26 indicates an operation sequence chart when a service is carried out;

FIG. 27 shows an operation sequence chart when a service is carried out;

FIG. 28 is a schematic diagram for indicating an operation example in the case that an address allocation is temporarily performed;

FIG. 29 is an illustration of a display example of a terminal; and

FIG. 30 is an illustration of a display example of a terminal.

### DETAILED DESCRIPTION OF THE PREFERRED EMBODIMENTS

Referring now to drawings, various embodiments of the present invention will be described.

### BASIC ARRANGEMENT/OPERATION OF MULTIMEDIA INFORMATION COMMUNICATION SYSTEM

### BASIC ARRANGEMENT

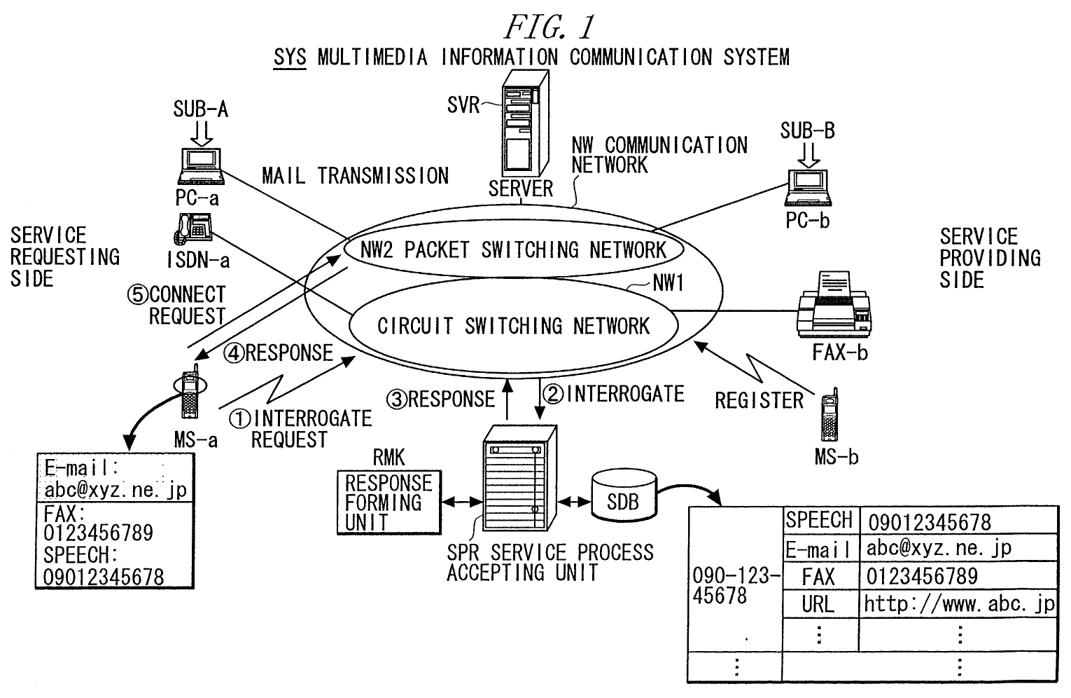

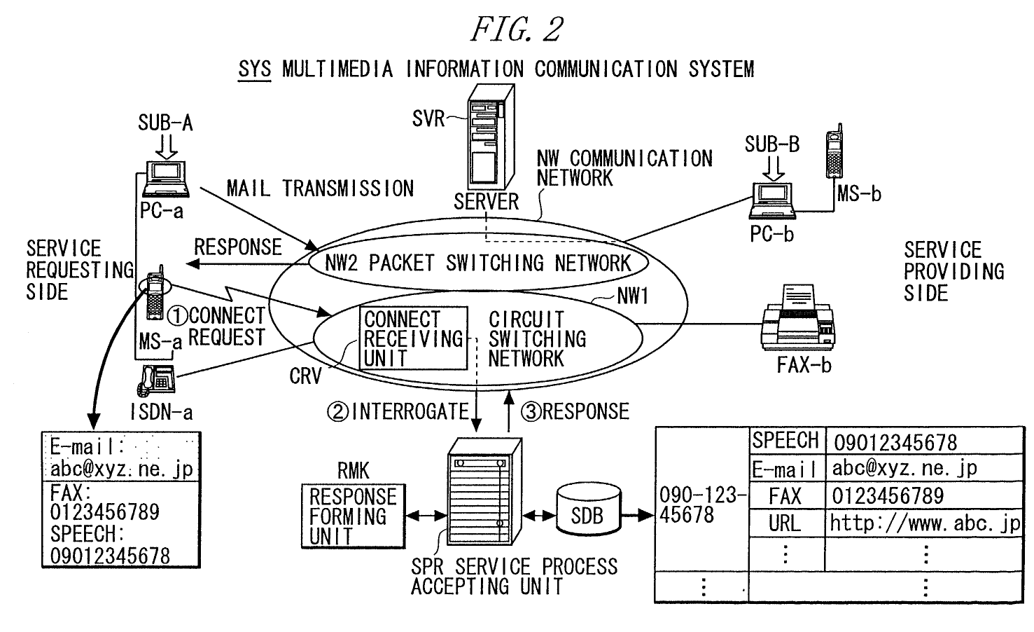

FIG. 1 and FIG. 2 represent a basic structural example of a multimedia information communication system SYS functioning as a communication service information providing system according to an embodiment of the present invention. This multi media information communication system SYS is provided with a communication network NW containing both a circuit switching network NW1 and a packet switching network NW2. This communication network NW contains both a Web server SVR and a service process accepting unit SPR.

The service process accepting unit SPR is connected to both a response forming unit RMK and a database SDB. The response forming unit RMK is utilized in the case that a response is made by way of information representation media different from information representation media which is used when a service response is interrogated. For example, when an interrogation is made by way of speech, a response is issued by way of a packet.

The database SDB previously stores therein plural sorts of communication services and the respective subscriber identifiers corresponding thereto, while a representative subscriber identifier is employed as a key. The communication service providing (registering) terminal SUB-B is used to subscribe, or join these plural sorts of communication services. In this case, the representative subscriber identifier is a telephone number corresponding to a speech communication service “Speech”.

In the communication network NW of this multimedia information communication system SYS, a communication service requesting (interrogating) terminal SUB-A and a communication service providing (registering) terminal SUB-B are involved.

A subscriber on the side of a communication service requester owns a portable telephone terminal MS-a, an ISDN-applicable telephone terminal ISDN-a, and a personal computer PC-a as the communication service requesting terminal SUB-A. The portable telephone terminal MS-a contains a liquid crystal display unit, and joins, or subscribes to such a communication service as a speech communication, a character (short message) communication, and a data (packet) communication.

Also, a subscriber on the side of a communication service provider owns a portable telephone terminal MS-b, a facsimile terminal FAX-b, and a personal computer PC-b as the communication service providing terminal SUB-B. The portable telephone terminal MS-b contains liquid crystal display unit, and joins or, subscribes to such a communication service as a speech communication, a character (short message) communication, and a data (packet) communication.

### OPERATION EXECUTED WHEN COMMUNICATION SERVICE IS REQUESTED

As indicated in FIG. 1, in the multimedia information communication system SYS with employment of the above-described arrangement, a subscriber on the side of the communication service provider previously registers into the database SDB, both a communication service which is subscribed to by the terminal owned by this subscriber and a subscriber identifier corresponding thereto as communication information.

In order that another subscriber on the side of the communication service requester uses the portable telephone terminal MS-a so as to grasp such a communication service to which the terminal MS-b owned by the subscriber on the side of the communication service provider is engaged, the first-mentioned subscriber sends a call to a preselected telephone number (calling) to issue an interrogation request. In this case, if the subscriber of the service request side has a desirable response style, it is designated. In this example, it is so assumed that this subscriber designates “packet (namely, electronic mail: E-mail)” as the response style.

The circuit switching network NW1 which receives the service request issued from the portable telephone terminal MS-a interrogates the service process accepting unit SPR as to the service subscribed to by the portable telephone terminal MS-b. The service process accepting unit SPR reads communication information (communication service and subscriber identifier thereof) related to the portable telephone terminal MS-b from the database SDB, and then supplies both the designated response style and the relevant communication information to a response forming unit RMK in order to form a response (answer).

Upon receipt of the response from the response forming unit RMK, the service processing accepting unit SPR returns the formed response to the packet switching network NW2 when the designated response style is the packet, or returns the formed response to the CIRCUIT SWITCHING network NW1 when the designated response style is either the short message communication (SME) or the facsimile communication (FAX). In this case, the service process accepting unit SPR returns the response to the packet switching network NW2.

The packet switching network NW2 sends this response to the portable telephone terminal MS-a. Both the communication service and the subscriber identifier corresponding thereto, which are contained in the response, are displayed on the display unit of the portable telephone terminal MS-a. The subscriber of the communication service request side may select a desirable communication service from the response displayed on the display unit to issue a call (connection request).

### OPERATIONS EXECUTED WHEN COMMUNICATION SYSTEM ENCOUNTERS WITH BUSY STATE

As represented in FIG. 2, in the multimedia information communication system SYS with employment of the above-described arrangement, a subscriber on the side of the communication service provider previously registers into the database SDB, both a communication service which is subscribed to by the terminal owned by this subscriber and a subscriber identifier corresponding thereto as communication information. Now, it is so assumed that the subscriber of the communication service provider side connects the portable telephone terminal MS-b to the personal computer PC-b so as to bring this portable telephone terminal MS-b into a use condition.

Under such a condition that the personal computer PC-a is connected, the subscriber of the communication service requester side uses the portable telephone MS-a so as to send out a connection request by way of the speech communication “Speech” with respect to the portable telephone terminal MS-b.

The connection receiving unit CRV of the circuit switching network NW1 which receives this connection request interrogates the service process accepting unit SPR about a service registered in the database SDB in order that a substituted communication service is notified to the portable telephone terminal MS-a, since the portable telephone terminal MS-b is under a busy state and thus, cannot be connected to another portable telephone terminal MS-a.

The service process accepting unit SPR acquires from the database SDB, such communication information related to the registered portable telephone terminal MS-b. The service process accepting unit SPR interrogates a desirable response style of the acquired communication information via the CIRCUIT SWITCHING network NW1 to the portable telephone terminal MS-a. In this case, it is now assumed that the portable telephone terminal MS-a designates “packet (electronic mail: E-mail)” as the desirable response style. Since the desirable response style is the packet, the service process accepting unit SPR causes the response forming unit RMK to form a response suitable for the packet.

The service process accepting unit SPR transmits the formed response via the packet switching network NW2 to the portable telephone terminal MS-a. Both the communication service and the subscriber identifier corresponding thereto, which are contained in the response, are displayed on the display unit of the portable telephone terminal MS-a. The subscriber of the communication service request side may select a desirable communication service from the response displayed on the display unit to issue a call. In this case, the subscriber transmits a mail to the personal computer PC-b via the personal computer PC-a connected to the portable telephone terminal MS-a.

### CONCRETE ARRANGEMENT AND OPERATION OF MULTIMEDIA INFORMATION COMMUNICATION SYSTEM

### CONCRETE ARRANGEMENT

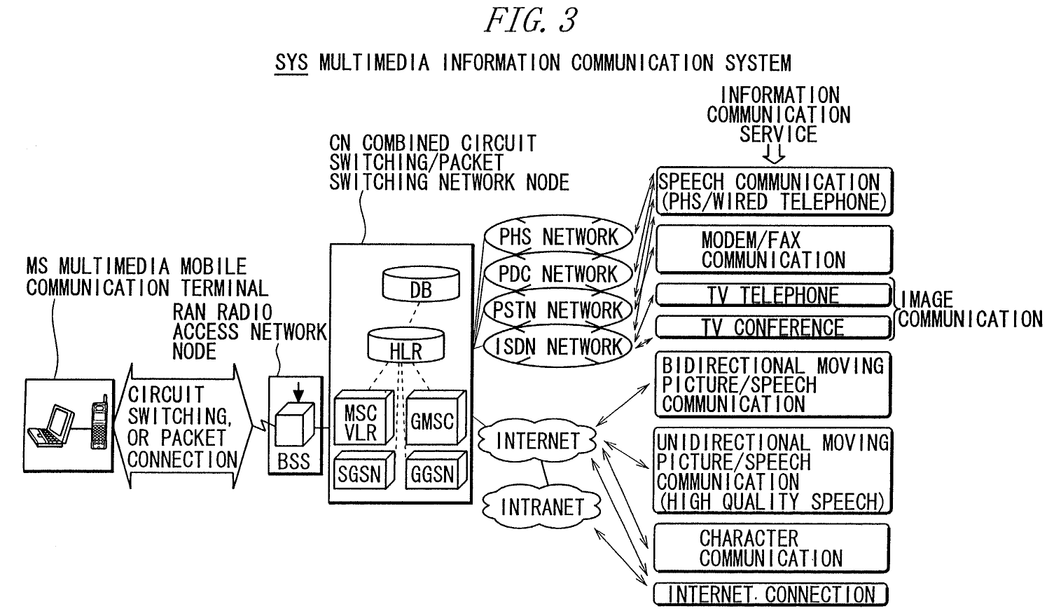

FIG. 3 indicates a concrete structural example of a multimedia information communication system according to one embodiment of the present invention. As to the multimedia information communication system shown in this drawing, the multimedia information communication system SYS that basic arrangement is indicated in FIG. 1 and FIG. 2 is embodied as a mobile communication system.

Referring now to FIG. 3, this mobile communication system SYS is provided with a wireless access network node RAN containing a wireless base station apparatus BSS. This wireless base station apparatus BSS stores a multimedia mobile communication terminal MS functioning as a multimedia terminal.

This mobile communication system SYS is further provided with a combined circuit switching/packet switching network node (namely, core network node) CN connected to the wireless access network node RAN. This combined circuit switching/packet switching network node CN contains as a circuit switching function unit, a mobile switching unit (mobile switching machine) MSC, a gateway mobile switching unit (GMSC) having a gateway connection function with respect to another network, and a visitor location register VLR. Also, the combined circuit switching/packet switching network node CN contains as a packet switching function unit, a packet switching unit SGSN, and a gateway packet switching unit GGSN having a gateway connection function with respect to another network.

Both the gateway mobile switching unit GMSC and the gateway packet switching unit GGSN of the combined circuit switching/packet switching network node CN are connected with a fixed telephone network such as a PHS, a PDC, and a PSTN; an N/B (Narrowband/Broadband)—ISDN network; and also an IP (Internet Protocol) communication network such as the Internet and the intranet.

As apparent from each of operation examples (will be discussed later), both the circuit switching function unit and the packet switching function unit of the combined circuit switching/packet switching network node CN are operated in either a separate manner or an interconnection manner in response to a communication service under handling.

This mobile communication system SYS is further provided with an interrogation database DB and a home location register HLR. In this drawing, both the interrogation database DB and the home location register HLR are indicated under logical arrangement condition. However, these interrogation database DB and the home location register HLR are physically arranged on the combined circuit switching/packet switching network node CN shown in this drawing, or another combined circuit switching/packet switching network node. These interrogation database DB and home location register HLR correspond to the databases SDB indicated in FIG. 1 and FIG. 2.

The interrogation database DB may provide (register) a list of communication services, and a request (interrogate) service (will be described in detail later). The home location register HLR corresponds to a subscriber database, and manages communication service subscribing conditions and locations of multimedia mobile communication terminals (subscribers) MS. It should be noted, in this embodiment, that the term “terminal (namely, multimedia mobile communication terminal and the like)” and the term “subscriber” may be used in view of the same implication.

The visitor location register VLR provided in the above-described node is provided in combination with the mobile switching unit MSC, and saves the subscriber data supervised by the mobile switching unit MSC. This visitor location register VLR may acquire the subscriber data from the home location register HLR when the multimedia mobile communication terminal MS registers its present location into the mobile switching unit MSC, and subsequently, the mobile switching unit MSC may perform a call control without accessing the home location register HLR.

In this multimedia information communication system SYS, the multimedia mobile communication terminal MS may accept, or receive plural sorts of services involved in the communication services such as the speech communication, the speech-added communication, the short message communication, and the data communication. As a consequence, the multimedia mobile communication terminal MS may transmit/receive information representative media in an arbitrary combination thereof and also an arbitrary quality (transfer speed and the like) to/from an arbitrary communication party at any location. As this information representative media, there are speech, data, characters, figures, still images, moving pictures, and the like.

As the multimedia mobile communication terminal MS, either a portable type multimedia mobile communication terminal mode or an on-vehicle type multimedia mobile communication terminal mode may be employed. Also, the multimedia mobile communication terminal MS may be arranged in a single body structure, and/or may be arranged in a composite body structure combined with another terminal such as a notebook type personal computer, a large-sized liquid crystal (LCD) display, and an automobile navigation machine.

It should also be noted that the wireless access network node RAN, the combined circuit switching/packet switching network node CN, the fixed telephone network, and the IP communication network which constitute this multimedia communication system SYS, correspond to the communication networks NW shown in FIG. 1 and FIG. 2, and may have such functions as the Web server SVR, the service process accepting unit SPR, the response forming unit RMK, the database SDB, and the connection receiving unit CRV.

Precisely speaking, in the above-described multimedia information communication system SYS according to an embodiment of the present invention, the combined circuit switching/packet switching network node CN may realize both a call control function and a mobile management function by using both a call control (CC) protocol and a mobility management (MM) in the circuit switching operation, and by using both a session management (SM) and a mobility management (GMM) for a general packet radio system (GPRS) (GMM:GPRS Mobility Management) in the packet switching operation. The call control function executes the communication control with respect to the multimedia mobile communication terminal MS. The mobile management function is performed in connection with movement of a terminal.

In the CC/SM (call control protocol/session management), a bearer change, a negotiation, and an additional service are controlled in addition to such a basic call control as a call setting control and a call releasing control. In the MM/GMM (mobility management/global mobility management), a mobility management control by registering a location, and a security control for instance is carried out where validity of the multimedia mobile communication terminal MS is confirmed, and also a subscriber identifier (IMSI International Mobile Subscriber Identifier) is replaced by a temporary identifier (TMSI:TemporaryMobile Subscriber Identifier) As to the CC/SM protocol and the MM/GMM protocol, for example, GSM (Global System for Mobile Communication)/GPRS may be employed as a base.

Between the radio access network node RAN and the combined circuit switching/packet switching network node CN, the following two functions may be realized, namely, a function capable of transparently transferring a call control/mobility management signal transmitted/received between the mobile communication terminal MS and the node CN into the node RAN, and another function capable of instructing paging and secret from the node CN to the node RAN. These functions may be provided by way of the RANAP (Radio Access Network Application Part) protocol.

Also, since the ATM technique is applied to the path between the node RAN and the node CN, such a low speed traffic as speech may be transferred highly efficiently by introducing the AAL (ATM Adaptation Layer) type 2. In this AAL type 2, the low speed traffic is transferred in the multiplexing mode, while the low speed traffic remains compressed/coded. As the protocol for performing these line controls, the AAL type 2 signaling protocol CS-1 (I.366.1,Q.2630.1) standardized by ITU-T (ITU-Telecommunication Standardization Sector) may be applied.

This multimedia information communication system SYS requires the following communications. That is, various types of traffics are required to be transferred effectively from the low speed communication such as speech up to the high speed communication such as moving pictures, the bearer is required to be changed during communication, and also the communications are required to be performed in upper/lower asymmetrical speeds. As the transfer system technique of the node CN, the ATM technique capable of satisfying these requirement conditions is applied. Also, in the case that the low-speed-coded speech is communicated among the mobile communication terminals, since the low-speed-coded speech is transferred within the node CN in the transparent manner by employing the AAL type 2 without performing the coding process operation to Φ-law, the deterioration of the speech quality caused by the coding process operation can be prevented, and also the network resource can be effectively used.

As the transfer system control protocol function capable of controlling both connections and calls on the ATM within the node CN, the B-ISUP (Broadband ISDN User Part) is utilized which corresponds to the protocol standardized in the ITU-T.

The mobile communication system is featured by such a mobility control as location registering operation, certification, and paging operation. These control functions may be provided by the MAP (Mobile Application Part) protocol. While the MAP protocol specific to the PDC network is used in the existing PDC network, the GSM evolved MAP corresponding to the expanded GSM-MAP is applied to this system, so that global roaming is realized.

### SUMMARIZE OF OPERATIONS OF MULTIMEDIA COMMUNICATION SYSTEM

Next, referring to FIG. 3 and the relevant diagram, operations of the multimedia information communication system SYS according to an embodiment of the present invention will now be summarized.

The multimedia information communication system (namely, mobile communication system) SYS indicated in FIG. 3 provides a providing service (registering service) of a communication service list and also a communication service list requesting (interrogating) service to both the multimedia mobile communication terminal MS and the multimedia fixed communication terminal ISDN.

The combined circuit switching/packet switching network node CN may execute registering/releasing/viewing operations of subscriber data related to joining of this service, similar to other additional service, with respect to the subscriber of the multimedia terminal which executes the provision/request services of the communication service list. To this end, the network node CN provides a subscriber data storage area related to this service inside both the home location register HLR and the visitor location register VLR.

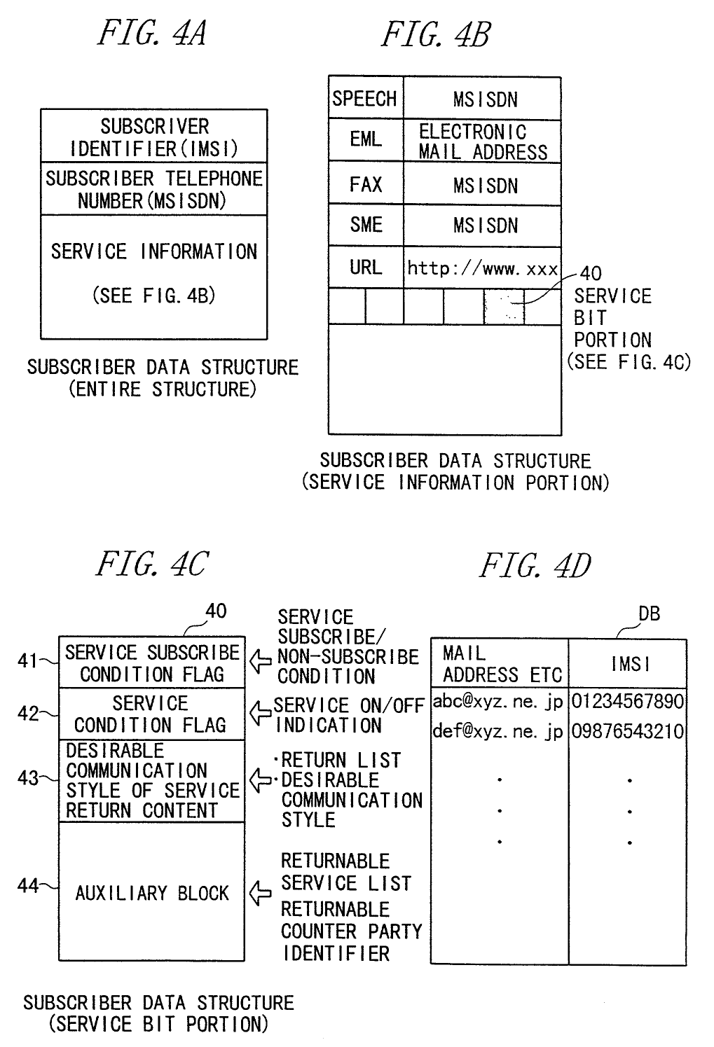

FIG. 4A illustratively shows an overall structure of the subscriber data storage area related to this service, which is formed within both the home location register HLR and the visitor location register VLR. In this subscriber data storage area, a representative subscriber identifier IMSI, a subscriber telephone number MSISDN, and service information are stored.

The representative subscriber identifier IMSI corresponds to identification information which represents a plurality of subscriber telephone numbers MSISDN. In this example, a telephone number used to a speech communication “Speech” is used. The subscriber telephone number MSISDN involves the telephone number for the speech communication “Speech”, the telephone number for the facsimile communication “FAX”, and telephone number for the short message communication “SME.”

FIG. 4B illustratively shows a detailed structure of a storage area for storing the service information. In this storage area of the service information, plural sorts of communication services and subscriber identifiers thereof are stored in correspondence to each other.

FIG. 4c shows a detailed structure of a service bit portion 40. This service bit portion 40 is constituted by a service subscribing condition flag 41, a service condition flag 42, a service return-list content desired communication style 43, and an auxiliary block 44. The service subscribing condition flag 41 shows a service subscribing/not-subscribing condition. The service condition flag 42 indicates a service ON/OFF indication, namely, an active state, or an inactive state of a service. The service return-list content desired communication style 43 is such information indicative of a desired communication (desired response/desired answer) style when a communication service list is returned. The auxiliary block 44 contains such information representative of a returnable service list and a returnable counter party identifier.

Also, an interrogation database DB is provided in the node CN (may be employed in existing network). This interrogation database DB stores therein such data other than a telephone number, which can be changed from a subscriber identifier, for example, an electronic mail (E-mail) address into the representative subscriber identifier IMSI (see FIG. 4D) . As a result of retrieving this interrogation database DB, such information saved in either the home LOCATION register HLR or the presence range LOCATION registers register VLR shown in FIG. 4A can be retrieved based upon the acquired representative subscriber identifier IMSI.

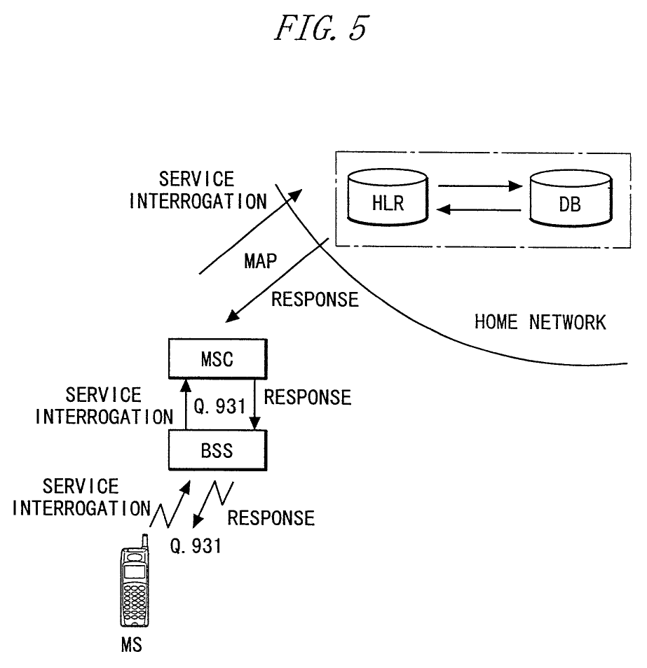

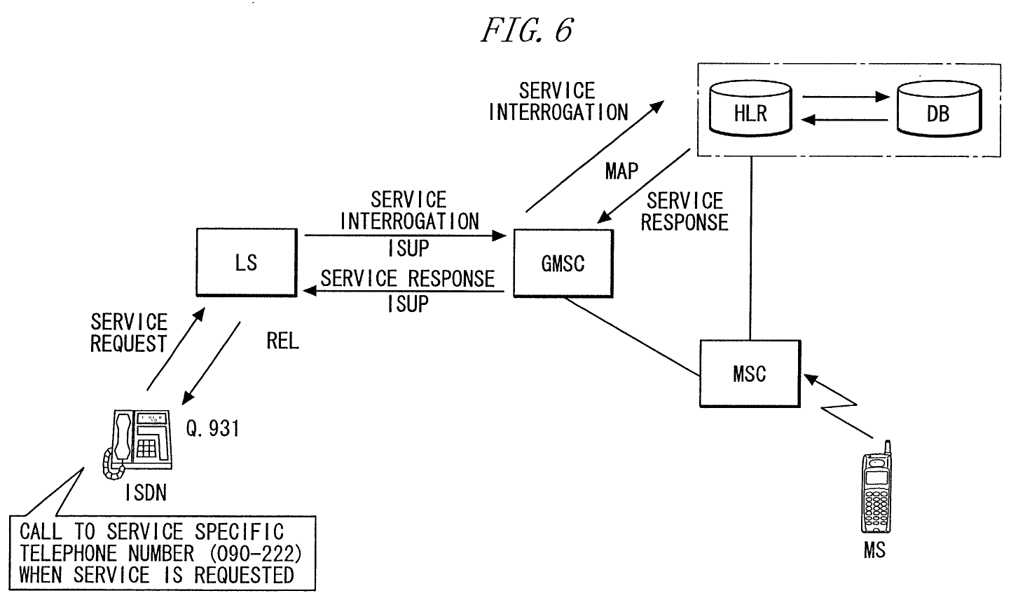

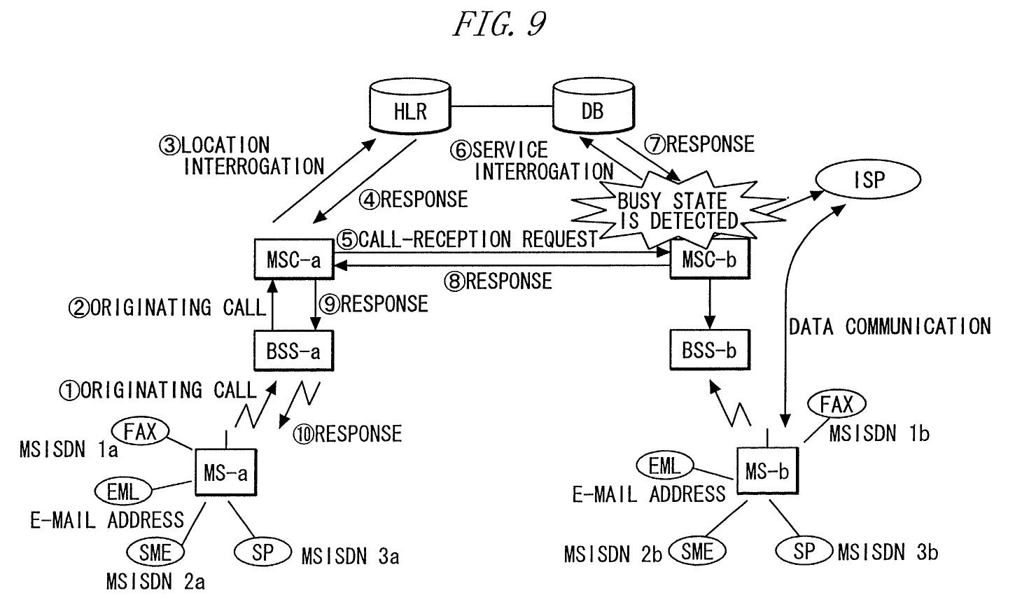

A subscriber (namely, interrogation subscriber) that will receive this service, namely a communication service request (interrogation)—sided subscriber that interrogates a communication service list calls a predetermined specific telephone number dedicated to this service so as to request this service (see FIG. 5 and FIG. 6). When a call is received, this service request may be automatically produced by an event occurrence recognizing switching unit at such a chance that an event such as a busy state happens to occur (see FIG. 9).

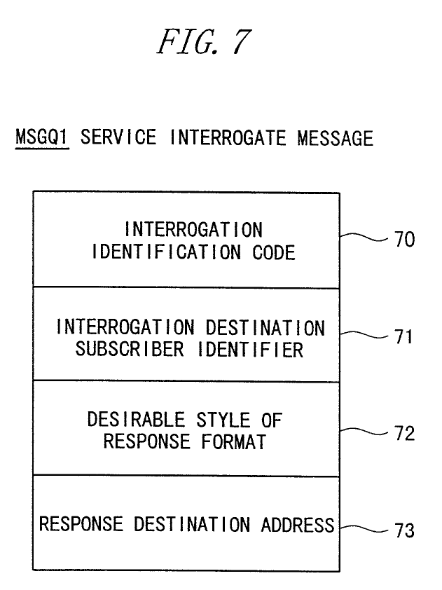

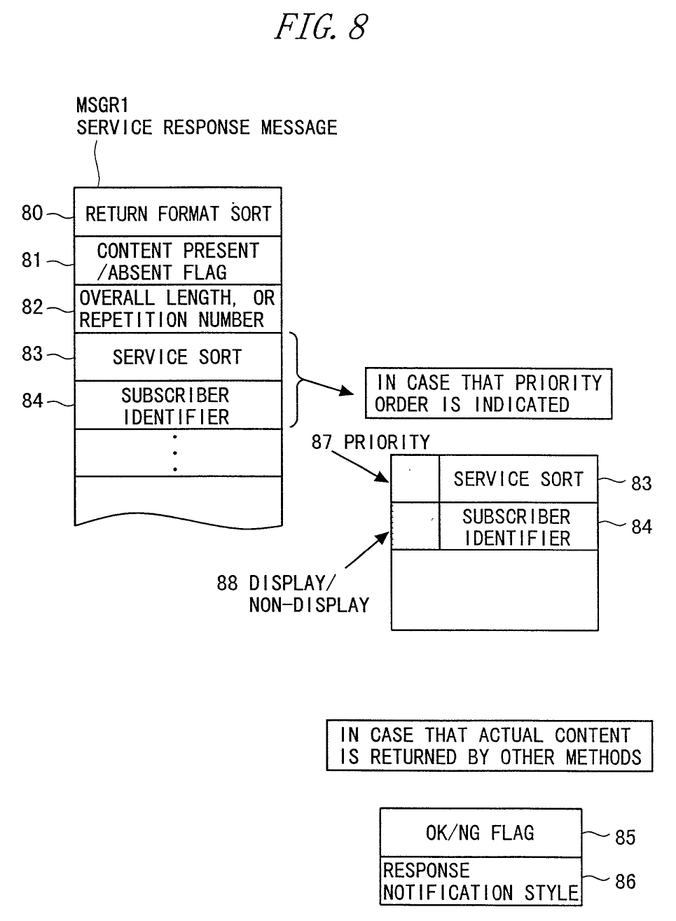

FIG. 5 represents an operation example in the case that this service interrogation is made from the multimedia mobile communication terminal (portable telephone terminal) MS. FIG. 6 shows another operation example in the case that this service interrogation is issued from the multimedia fixed communication terminal (ISDN-adaptive telephone terminal). In this embodiment, such a message in GSM/UMTS (Global system for Mobile Communications/Universal Mobile Telecommunication System) is described as an example. FIG. 7 and FIG. 8 show an example of a format of a service interrogation message MSGQ1, and also a format of a service response message MSGR1.

As indicated in FIG. 5, in the case that this service interrogation is made from the multimedia mobile communication terminal MS, the service interrogation message MSGQ1 which utilizes a Q.931 Facility message transmitted from the mobile communication terminal MS is transmitted in such a manner that this service interrogation message is reached to the subscriber home location register HLR of the communication service providing (registering) side.

In other words, the service interrogation message MSGQ1 transmitted from the mobile communication terminal MS is received via the wireless base station apparatus BSS by the mobile switching unit MSC. The mobile switching unit MSC transmits the received service interrogation message MSGQ1 in the form of such a message defined by the MAP (Mobile Application Part) protocol to the home location register HLR.

Since this MAP protocol is used, any subscribers may issue both the service interrogation and a service response (will be discussed later) even among the different telephone industries. Both the service interrogation message MSGQ1 and the service response message MSGR1 are transmitted/received by using the GTT (Global Title Translation) function of the MAP protocol, while using as a key either the service interrogation message MSGQ1 and the service response message MSGR1.

In the case that the communication service providing terminal is designated by the subscriber telephone number MSISDN, a database processor (not shown in detail) may specify the home location register HLR similar to the existing process operation. This database processor interrogates the interrogation database DB in the case that the communication service providing terminal is designated by other identifiers than the subscriber telephone number MSISDN, for instance, an electronic mail address, and then retrieves the representative subscriber identifier IMSI. Thereafter, this processor sends out the service interrogation message MSGQ1 to the home LOCATION register HLR by using an identifier contained in this retrieve response.

Both the home location register HLR and the interrogation database DB transmit the service response message MSGR1 to the mobile switching unit MSC in order to visually display this service response message MSGR1 on the liquid crystal display unit of the multimedia mobile communication terminal MS. This service response message MSGR1 contains such a communication service and communication information of a subscriber identifier corresponding thereto, which are obtained from the retrieved result based on the service interrogation message MSGQ1.

Also, as indicated in FIG. 6, in the case that this service is interrogated from the multimedia fixed communication terminal (ISDN-adaptive telephone terminal) ISDN, this multimedia fixed communication terminal ISDN calls a predetermined service specific number so as to request a service. The switching unit LS of the ISDN network (see FIG. 3) which receives this service specific number transmits the service interrogation message MSGQ1 defined by the ISUP protocol to the gateway mobile switching unit GMSC connected to the mobile switching unit MSC for storing the communication service providing terminal MS.

The gateway mobile switching unit GMSC transmits the received service interrogation message MSGQ1 in the form defined by the MAP protocol to the home location register HLR. Similar to the above-explained manner, since the MAP protocol is utilized, any subscriber can realize both the service interrogation and a service response (will be discussed later) even when the different telephone industries are utilized. Both the service interrogation message MSGQ1 and the service response message MSGR1 are transmitted/received by using the GTT (Global Title Translation) function of the MAP protocol, while using as a key either the service interrogation message MSGQ1 and the service response message MSGR1.

In the case that the communication service providing terminal is designated by the subscriber telephone number MSISDN, a database processor (not shown in detail) may specify the home location register HLR similar to the existing process operation. This database processor interrogates the interrogation database DB in the case that the communication service providing terminal is designated by other identifiers than the subscriber telephone number MSISDN, for instance, an electronic mail address, and then retrieves the representative subscriber identifier IMSI. Thereafter, this processor sends out the service interrogation message MSGQ1 to the home location register HLR by using an identifier contained in this retrieved response.

Both the home location register HLR and the interrogation database DB transmits the service response message MSGR1 to the gateway mobile switching unit GMSC. This service response message MSGR1 contains such a communication service and communication information of a subscriber identifier corresponding thereto, which are obtained from the retrieved result based on the service interrogation message MSGQ1.

The switching unit LS which receives the service response message MSGR1 from the gateway mobile switching unit GMSC utilizes a REL (release) message of Q. 931 in order to visually display the above-explained communication information on the multimedia fixed communication terminal ISDN. In order to visually display this service response message MSGR1, the existing information element (for example, UUS-IE: User to User Signalling Information Element etc.) contained in the REL message may be utilized.

FIG. 7 and FIG. 8 indicate a format example of the above-explained service interrogation service MSGQ1, respectively, and another format example of the above-described service response message MSGR1.

As represented in FIG. 7, the service interrogation message MSGQ1 contains an interrogation identification code 70, an interrogation destination subscriber identifier 71, a response format desirable style 72, and a response destination address 73. The interrogation identification code 70 shows a communication service request code. The interrogation destination subscriber identifier 71 corresponds to subscriber information (IMSI, or MSISDN) used to designate a subject multimedia terminal which requests a communication service. Both the response format desirable style 72 and the response destination address 73 correspond to such option information which is designated in the case that these style and address designated when the interrogation is made are different from the originally designated style and address.

As shown in FIG. 8, the service response message MSGR1 contains a return format sort 80, a content present/absent flag 81, an entire length (Length)/repetition number 82, a service (communication service) sort 83, and a subscriber identifier 84.

In the case that the service response message MSGR1 is returned with the same information representation media as that of the interrogation, the response is made in this message format. However, in the case that the service response message MSGR1 is returned with the different information representation media from that of the interrogation, for example, when an electronic mail is returned with respect to an interrogation made by a speech, both an OK/NG flag 85 and a response notification style 86 are first returned. After the accepting condition of this service has been notified, an actual content is returned by using the electronic mail.

The return format sort 80 of the service response message MSGR1 indicates a return format, for example, that represents that only a communication service is returned, and both a communication service and a subscriber identifier are returned. The content present/absent flag 81 shows the present/absent state of the return content. Only when the content present/absent flag 81 represents the present state, the entire length/repetition number 82, the service sort 83, and also the subscriber identifier 84 may become valid as the option information. When the return contents own priority orders, a priority display flag 87 of the service sort 83 is used. Also, a decision as to whether or not the respective subscriber identifiers 84 are returned may use a display/not-display flag 88 of the subscriber identifier 84.

Referring now to FIG. 9 to FIG. 13, operations of providing this service when the busy state is detected will be described.

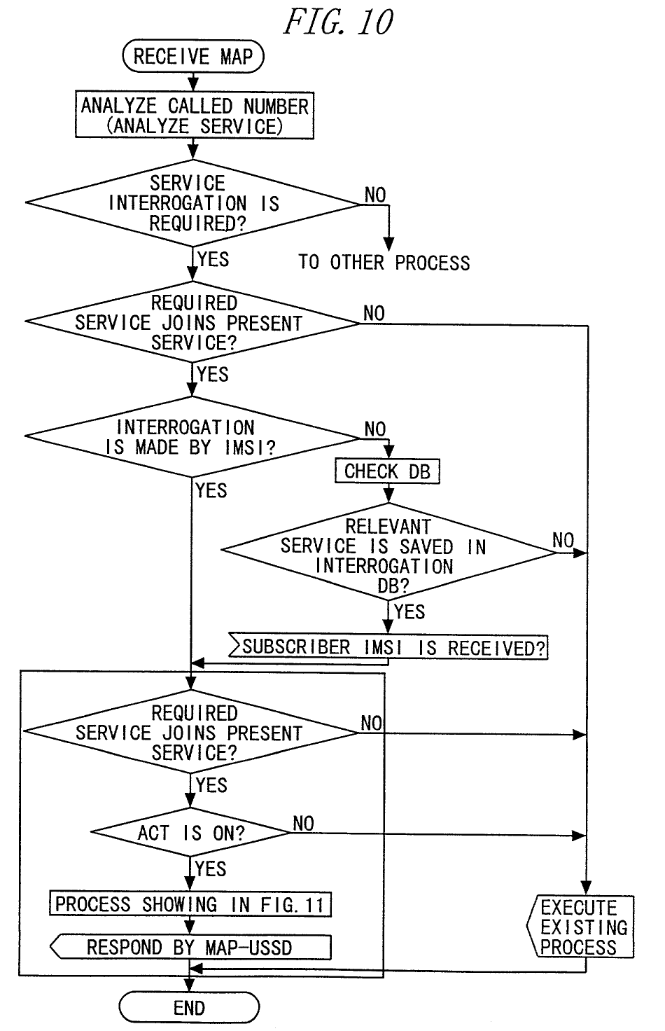

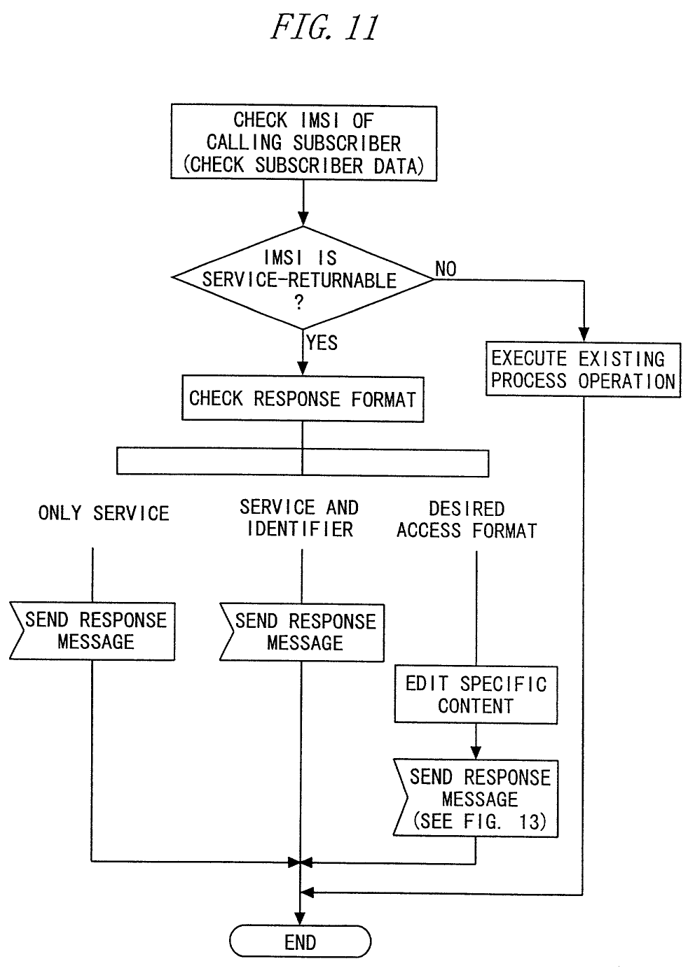

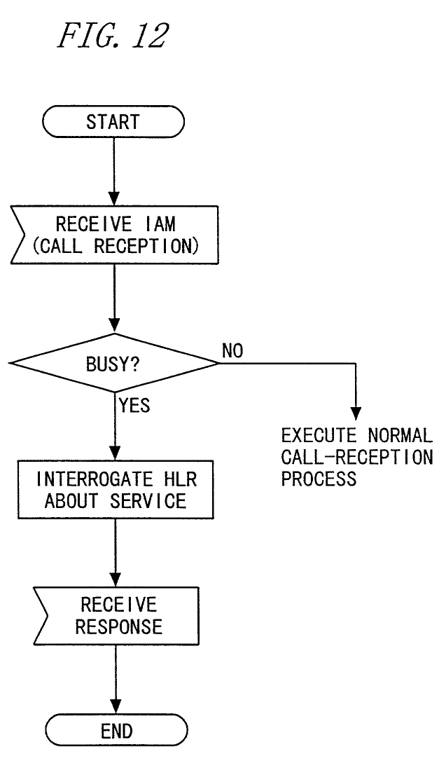

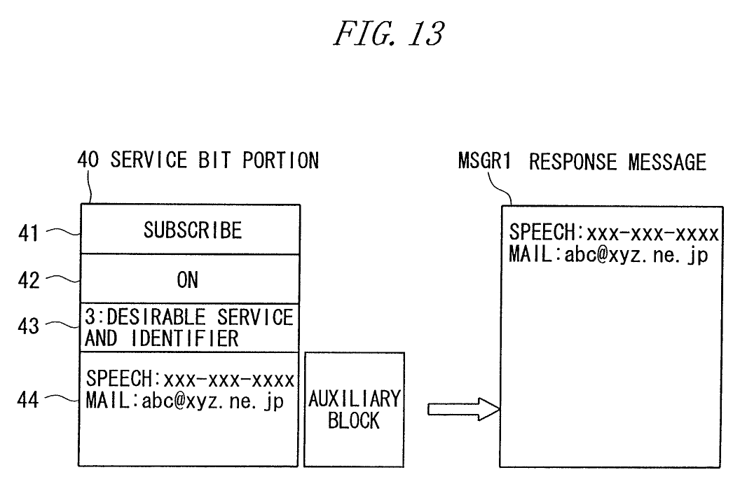

FIG. 9 illustratively shows a structural example of a multimedia information communication system which provides this service when the busy state is detected. FIG. 10 schematically shows an operation sequence of the home location register when a service interrogation request is received. FIG. 11 schematically represents an operation sequence of the home location register when a response message is edited. FIG. 12 schematically represents an operation sequence of the switching unit in the case that a busy state is detected and a service request is received. FIG. 13 schematically shows an example in the case that a response message is edited.

In the multimedia information communication system (mobile communication system) SYS indicated in FIG. 9, both the multimedia mobile communication terminal MS-a and the multimedia mobile communication terminal MS-b are used to subscribe to, or join a plurality of communication services, respectively. In this example, each of these multimedia mobile communication terminals MS-a and MS-b joins a speech communication (Sp), a short message communication (SME), a facsimile communication (FAX), and an electronic mail (EML). Also, the multimedia mobile communication terminals MS-a and MS-b own a subscriber identifier (both subscriber telephone number MSISDN and E mail address) every service.

It is now assumed that while the multimedia mobile communication terminal MS-b makes up an originating call (speech communication), a subscriber operates a notebook type personal computer (PC) to execute the Internet surfing, namely to perform a data communication in a packet mode. Under this condition, when the multimedia mobile communication terminal MS-a issues an originating call (call request) to the multimedia mobile communication terminal MS-b in order to establish a speech communication, this multimedia mobile communication terminal MS-a encounters with the busy state of the second-mentioned multimedia mobile communication terminal MS-b during the normal switching process operation, and therefore, this originating call is refused.

At this time, if both another service subscribed to by the communication counter party, namely the multimedia mobile communication terminal MS-b, and also an identifier to be transmitted to this service are provided to the multimedia mobile communication terminal MS-a, then another service, namely the communication by way of the electronic mail may be carried out, since the personal computer PC is operated by the multimedia mobile communication terminal MS-b.

As a consequence, both the interrogation database DB and the home location register HLR, which receive the service interrogation issued from the mobile switching unit (mobile switching unit) MSC-b which has detected the busy state of the multimedia mobile communication terminal MS-b, retrieves the subscriber data (see FIG. 4) from the subscriber identifier contained in the service interrogation. Then, the interrogation database DB and the home location register HLR confirm the registering condition of this service of the multimedia mobile communication terminal MS-b, edit the response message (see FIG. 13) in response to the content of this registering condition, and then return the edited response message to the multimedia mobile communication terminal MS-a.

It should be noted that in FIG. 9, symbols “BSS-a” and “BSS-b”show wireless base stations, symbol “MSC-a” represents a mobile switching unit (mobile switching machine), and symbol “ISP” shows the Internet service provider.

With respect to the protocols used to send various sorts of messages transmitted/received in this multimedia information communication system SYS, Q.931 corresponds to a protocol for defining a call setting message which is transmitted/received between the ISDN terminal and the switching unit. In this case, messages can be transferred between the multimedia mobile communication terminals MS-a, MS-b, and the mobile switching units MSC-a, MSC-b.

Also, the ISUP (ISDN User Part) is such a protocol for defining the message transfer operation between the mobile switching units MSC-a and MSC-b. The ISUP protocol may be substituted by either the MFC (Multi-Frequency Compelled) protocol or the TUP (Telephone User Part) protocol.

The MAP (Mobile Application Part) protocol is such a protocol for defining a message specific to a mobile communication which is not related to a call. As this MAP protocol, there are three sorts of protocols, namely the GSM-MAP (Global system for Mobile Communications-Mobile Application Part) protocol, the IS (Interim Standard)-41-MAP protocol, and the PDC (Personal Digital Cellular Telecommunication System)-MAP protocol.

### FIRST OPERATION EXAMPLE

This multimedia information communication system SYS owns plural sorts of communication functions. In this multimedia information communication system SYS, as to a subscriber (namely, service providing (registering) subscriber) B of such a multimedia mobile communication terminal (MS), that subscribes to such communication services as a speech communication (SP), a short message (SME) communication, a facsimile communication (FAX), and a packet communication (electronic mail: EML), the services held by the subscriber B himself; the subscriber identifiers used to access the respective services; both the desirable access format and the subscriber identifier thereof which are previously registered by the subscriber B; and the refuse state are responded, or replied with respect to another subscriber A (namely, either service request (interrogation) subscriber or service request subscriber) of the multimedia fixed communication terminal (ISDN), that issues a service interrogation irrespective of an originating call.

It should be understood that various sorts of messages and functions thereof, which are defined by the Q.931, ISUP and MAP protocols utilized in the below-mentioned respective operation examples are the same as the normally used message names and functions thereof unless a specific explanation thereof is made.

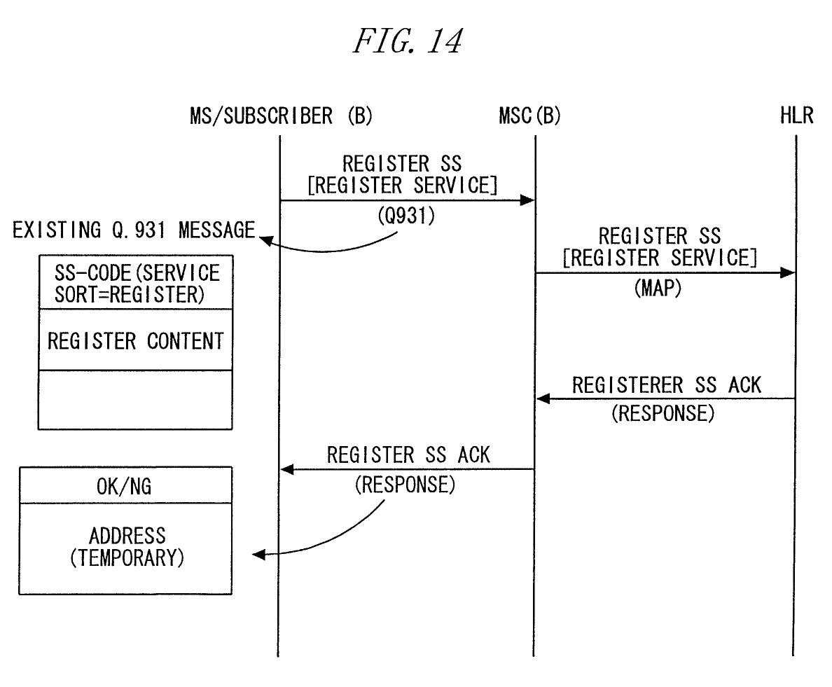

(1) OPERATION (SEE FIG. 14) OF SUBSCRIBER (SERVICE PROVIDING SUBSCRIBER) B OF MULTIMEDIA MOBILE COMMUNICATION TERMINAL, SUBSCRIBING TO PRESENT SERVICE:

The subscriber B of the multimedia mobile communication terminal, that subscribes to the present service, previously subscribes to a service, and registers a content of a return interrogation when a service interrogation is issued by utilizing the existing message. While the existing register control sequence shown in FIG. 14 is directly utilized, a code for the present service is newly added to a service code of each message.

When the subscriber B subscribes to the present service, such information as a communication service is registered into the home location register HLR, while using the service register messages of the Q.931 and MAP protocols. In order to confirm the registered condition, a response message is returned to the subscriber B.

The activation/inactivation of this service may be carried out in a similar manner to the above-described sequence. It should also be noted that similar to other services, this service may be activated for every bearer, namely for every communication service. In the case of such a subscriber B that owns the subscriber identifiers corresponding to plural sorts of services and also uses the multimedia mobile communication terminal, when this subscriber B subscribes to this service, such a request message is sent from the home location register HLR to the interrogation database DB. This request message is used to form a correspondence table between a subscriber identifier and a mobile subscriber identifier IMSI.

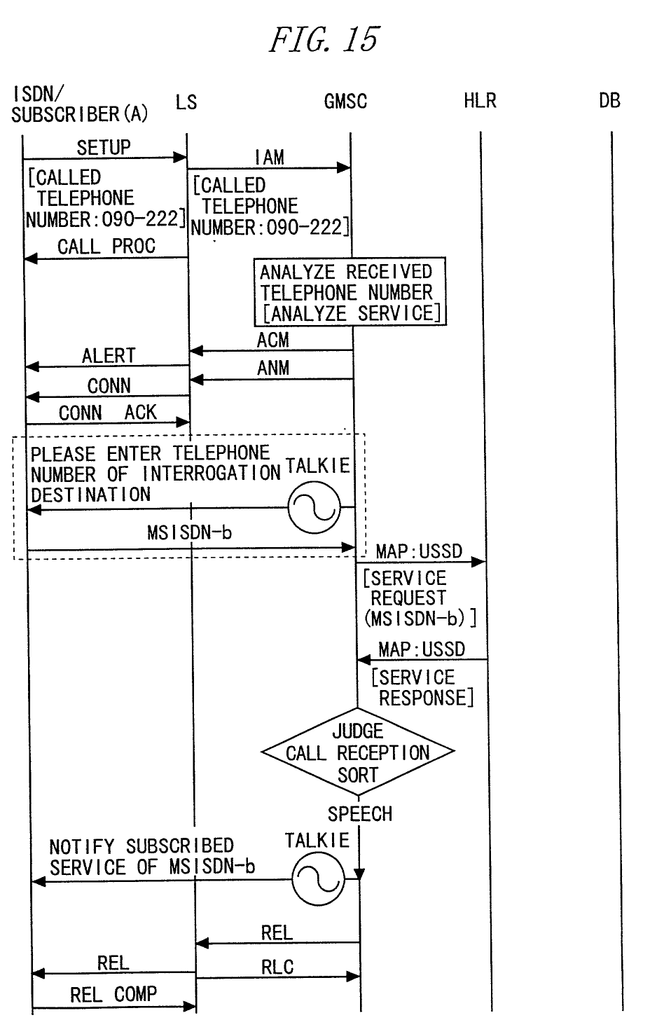

(2) OPERATIONS EXECUTED WHEN PRESENT SERVICE IS INTERROGATED (SEE FIG. 15):

The subscriber A of the multimedia fixed communication terminal (ISDN-adaptive telephone terminal) on the side of the service interrogator issues an originating call to a service specific telephone number “called number: 090-222” so as to send a service request. In this case, this subscriber A enters information, for instance, a subscriber telephone number MSISDN of the multimedia mobile communication terminal (subscriber B) of the communication counter party.

In this operation example, based upon the received originating call, the gateway mobile switching unit GMSC recognizes that the access request is issued to this service. When all of the necessary information is not yet received, a talkie apparatus (Talkie) is connected to the subscriber A so as to acquire the contents of the service request in accordance with guidance. A response from the subscriber A to the talkie apparatus is made by using a PB signal.

In such a case that the gateway mobile switching unit GMSC of the subscriber B cannot specify the interrogated gateway mobile switching unit GMSC, or the interrogated home location register HLR based upon the information of the subscriber B, e.g., an electronic mail address, an interrogation message is sent out to the interrogation database DB. The interrogation database DB returns such a response containing the representative subscriber identifier IMSI.

The mobile switching unit GMSC which receives the service request issued from the subscriber A interrogates the home location register HLR as to a service usable by the subscriber B by utilizing MAP-USSD (Non-structural Supplementary Service Data).

The home location register HLR notifies the service usable by the subscriber B to the mobile switching unit GMSC by utilizing the MAP-USSD. In response to a sort of calling made by the subscriber A, the mobile switching unit GMSC notifies a service allowable by the subscriber B. In other words, when the gateway mobile switching unit GMSC receives the service response message from the home location register HLR, this gateway mobile switching unit-GMSC confirms a response format requested by the interrogator, and captures the necessary resource to return the response. In this operation example, the gateway mobile switching unit GMSC captures the talkie apparatus, and then transmits the response content to the subscriber A.

### SECOND OPERATION EXAMPLE

This multimedia information communication system SYS owns plural sorts of communication functions. In this multimedia information communication system SYS, as to a subscriber (namely, service providing subscriber) B of such a multimedia mobile communication terminal (MS), that subscribes to the above-explained communication services, a home page address URL which has been previously registered by the subscriber B is responded, or replied with respect to another subscriber (namely, either service request (interrogation) subscriber or service request subscriber) of the multimedia mobile communication terminal (MS), that issues a service interrogation irrespective of a call.

(1) OPERATIONS OF SUBSCRIBER (SERVICE PROVIDING SUBSCRIBER) B OF MULTIMEDIA MOBILE COMMUNICATION TERMINAL, THAT SUBSCRIBES TO THIS SERVICE:

This operation is similar to the first operation example. However, it should be noted that as a content to be registered, such a home page address URL which is wanted to be responded is registered. An area used for this home page may be prepared by the operation side, or may be owned by individuals. Also, there is no specific definition as to a content of a home page.

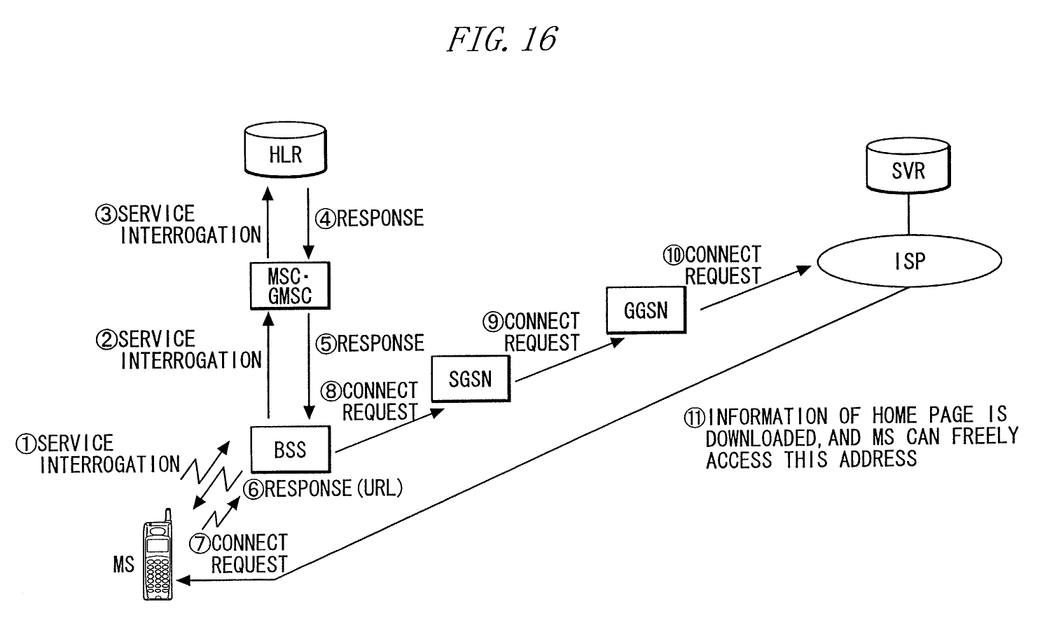

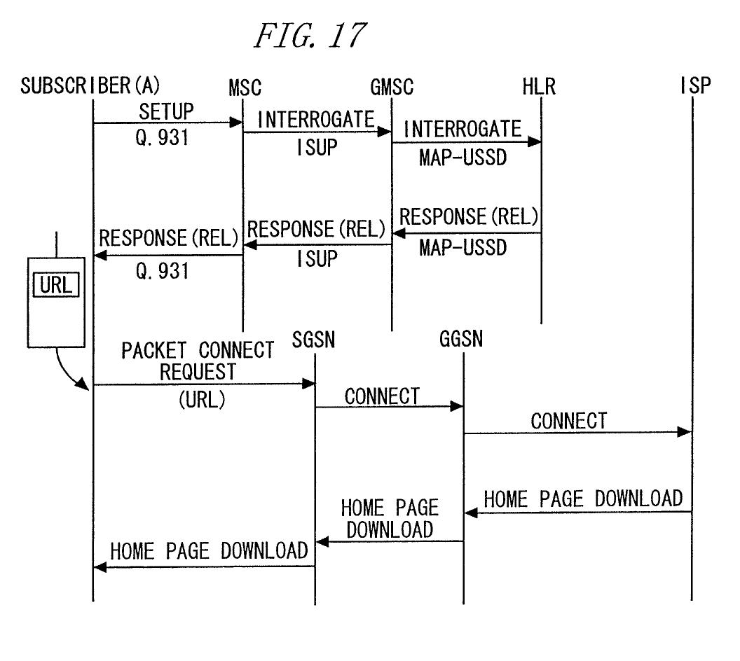

(2) OPERATIONS EXECUTED WHEN PRESENT SERVICE IS INTERROGATED (SEE FIG. 16 AND FIG. 17):

The subscriber A of the multimedia mobile communication terminal on the side of the service interrogator issues an originating call to a service specific telephone number so as to send a service request. In this case, this subscriber A enters information, for instance, a subscriber telephone number MSISDN of subscriber B of the communication counter party. In such a case that the gateway mobile switching unit GMSC of the subscriber B cannot specify the interrogated gateway mobile switching unit GMSC, or the interrogated home location register HLR based upon the information of the subscriber B, e.g., an electronic mail address, an interrogation message is sent out to the interrogation database DB. The interrogation database DB returns such a response containing the representative subscriber identifier IMSI.

The mobile switching unit GMSC which receives the service interrogation request issued from the subscriber A interrogates the home location register HLR as to a service allowable by the subscriber B by utilizing the MAP-USSD. The home location register HLR notifies the home page address URL which is registered by the subscriber B to the mobile switching unit MSC as the service response by utilizing the MAP-USSD. The mobile switching unit MSC notifies the home page address URL via the wireless base station apparatus BSS to the subscriber A.

When the subscriber A issues an originating call to this home page address URL, a connection request is transmitted via both the packet switching unit SGSN and the gateway packet switching unit GGSN to the server SVR of the Internet service provider. As a result, the information related to this home page is downloaded from the server SVR, so that the subscriber A can freely access to the address of this home page, namely the subscriber identifier.

### THIRD OPERATION EXAMPLE

This multimedia information communication system SYS owns plural sorts of communication functions. In this multimedia information communication system SYS, as to the subscriber (service providing subscriber) B of the multimedia mobile communication terminal (MS), that subscribes to the above-described communication service, the registered information such as the services owned by the subscriber “B” himself and the subscriber identifiers used to access the respective services is replied in the form of information representation media such as speech, data, characters, figures, still images, and moving images, which are desired by the subscriber “A” with respect to the subscriber (either service request subscriber or originating caller) “A” of the multimedia fixed communication terminal (ISDN), that executes the service interrogation irrespective of an originating call.

(1) OPERATIONS OF SUBSCRIBER (SERVICE PROVIDING SUBSCRIBER) B OF MULTIMEDIA MOBILE COMMUNICATION TERMINAL, THAT SUBSCRIBES TO THIS SERVICE:

This operation is carried out in a similar manner to the above-explained first operation example.

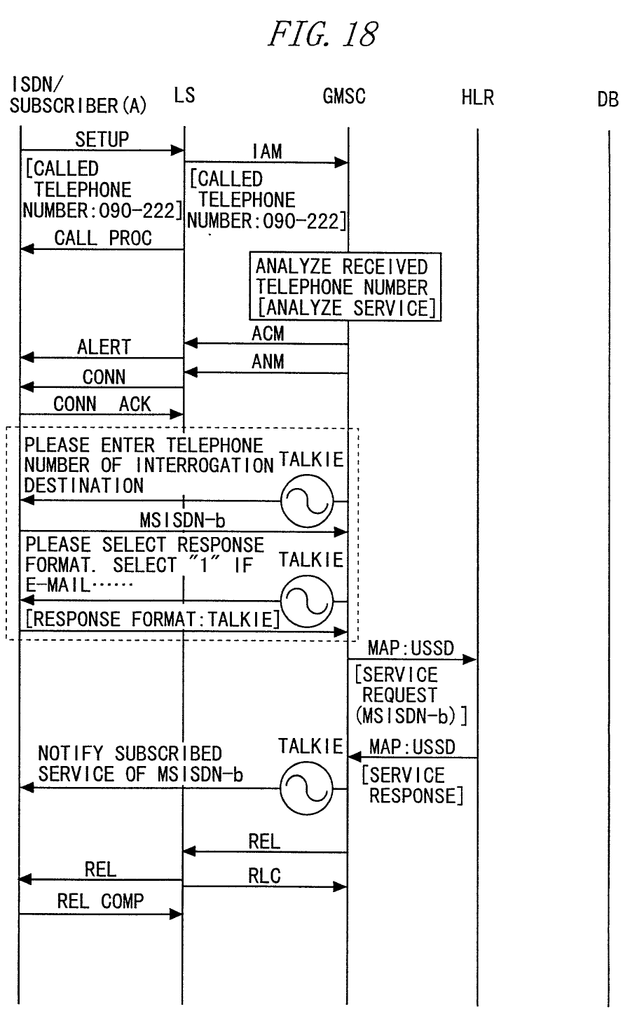

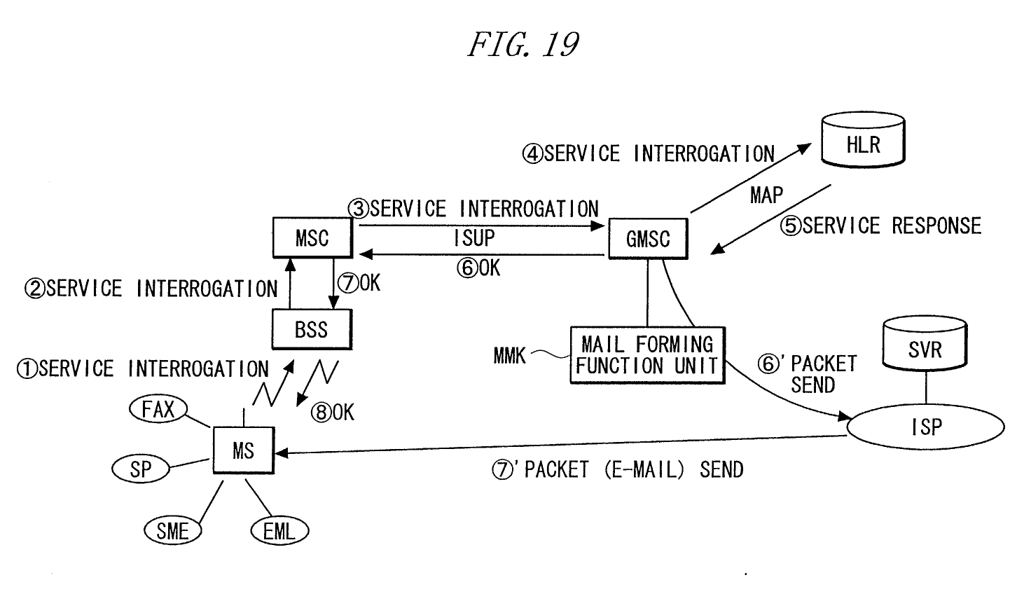

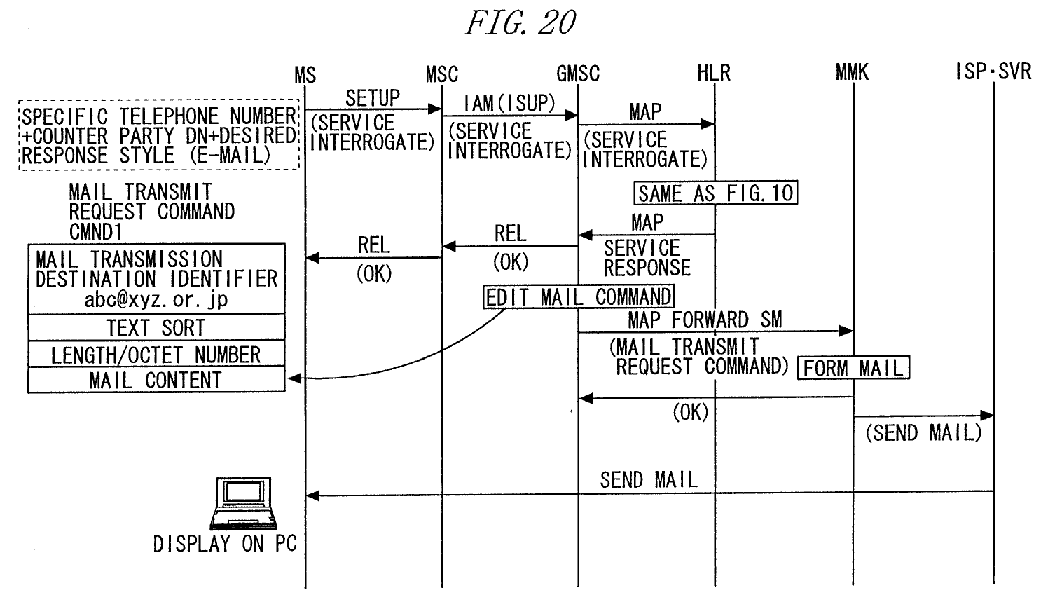

(2) OPERATIONS EXECUTED WHEN THIS SERVICE IS INTERROGATED (SEE FIG. 18, FIG. 19, FIG. 20):

First referring to FIG. 18, the subscriber A of the multimedia fixed communication terminal (ISDN-adaptive telephone terminal) on the side of the service interrogator issues an originating call to the service specific telephone number (called number: 090-222) so as to request a service. In this case, both the information (for example, subscriber telephone number MSISDN) of the multimedia mobile communication terminal (subscriber B) of the communication counter party, and also the desirable response style, namely a sort (e.g., speech) of information representation media are entered.

In this operation example, based upon the received originating call, the gateway mobile switching unit GMSC recognizes that the access request is issued to this service. When all of the necessary information is not yet received, a talkie apparatus (Talkie) is connected to the subscriber A so as to acquire the contents of the service request in accordance with guidance. A response from the subscriber A to the talkie apparatus is made by using a PB signal.

In such a case that the gateway mobile switching unit GMSC of the subscriber B cannot specify the interrogated gateway mobile switching unit GMSL, or the interrogated home location register HLR based upon the information of the subscriber B, e.g., an electronic mail address, an interrogation message is sent out to the interrogation database DB. The interrogation database DB returns such a response containing the representative subscriber identifier IMSI.

The mobile switching unit GMSC which receives the service request issued from the subscriber A interrogates the home location register HLR as to a service usable by the subscriber B by utilizing MAP-USSD.

The home location register HLR notifies such a service usable by the subscriber B to the mobile switching unit GMSC by using the MAP-USSD. The mobile switching unit GMSC notifies such a service allowable by the subscriber B by way of the information representation media (speech=Talkie) of the desirable response style of the subscriber A. In other words, in the case that the gateway mobile switching unit GMSC receives the service response message from the home location register HLR, this gateway mobile switching unit GMSC confirms a response format which is required by the interrogation source, and then captures the necessary resource to return the response. In this operation example, the gateway mobile switching unit GMSC captures the talkie apparatus, and then transmits the response content to the subscriber A.

Also, in such a case that the subscriber A of the multimedia mobile communication terminal on the side of the service interrogator issues an originating call to the service specific telephone number “called number: 090-222” so as to request a service, when both the information “electronic mail address: E-mail” of the multimedia mobile communication terminal (subscriber B) of the communication counter party, and also “E-mail” as the desirable response style are inputted, operations are brought into such operation conditions as indicated in FIG. 19 and FIG. 20.

In other words, in the case that the gateway mobile switching unit GMSC transmits the received service interrogation message MSGQL to the home location register HLR and then, returns the service response message MSGR1 containing the OK flag 85 (see FIG. 8), the gateway mobile switching unit GMSC transmits this service response message MSGR1 to the subscriber A of the multimedia mobile communication terminal MS. At the same time, the gateway mobile switching unit GMSC edits a mail transmission request command CMND1, and requests the mail forming function unit MMK to form a mail in accordance with, for instance, the TCP/IP (Transmission Control Protocol/Internet Protocol) protocol.

The mail transmission request command CMND1 contains such information as a mail transmission destination identifier, a text sort, and a mail content, and the like. The mail forming function unit MMK transmits the mail formed based upon the received command CMND1 via the Internet service provider ISP to the server SVR in the packet form.

The server SVR transmits the mail via the Internet service provider ISP, a packet switching unit SGSN (not shown), and the gateway packet switching unit GGSN to the personal computer PC of the multimedia mobile communication terminal MS of the subscriber A, and then displays the content of this mail on this personal computer PC.

In this case, the mail forming function unit MKK corresponds to such a function part which is newly added to the mobile switching unit MSC, and may be realized by a server which is connected to the mobile switching unit MSC in the form of 10BASE-T. Also, the mail forming function unit MMK is directly connected to the Internet service provider ISP. When the mail transmission request command CMND1 is received, the mail forming function unit MMK owns such a function capable of converting the text portion of the mail content into either an HTML (Hyper Text Markup Language) format or a compact HTML format, and also capable of transmitting the format-converted text portion to the server SVR.

### FOURTH OPERATION EXAMPLE

This multimedia information communication system SYS owns plural sorts of communication functions. In this multimedia information communication system SYS, as to the subscriber (service providing subscriber) B of the multimedia mobile communication terminal (MS), that joins the above-described communication service, when the multimedia information communication system SYS cannot be connected to the subscriber B due to some reasons such as a busy state, the following items are responded, or replied with respect to the subscriber (either service request subscriber or originating caller) A of the multimedia fixed communication terminal (ISDN), that executes the service interrogation irrespective of an originating call. As these replied items, there are services held by the subscriber B himself; subscriber identifiers used to access the respective services, which have been previously registered by the subscriber B, a desirable access format and a subscriber identifier thereof, which have been previously registered by the subscriber B; and also a refuse state.

(1) OPERATIONS OF SUBSCRIBER (SERVICE PROVIDING SUBSCRIBER) B OF MULTIMEDIA MOBILE COMMUNICATION TERMINAL, THAT SUBSCRIBES TO THIS SERVICE:

This operation is carried out in a similar manner to the above-explained first operation example. It should be noted that as a content to be registered, such a condition may be registered. That is, a communication service is returned in which case.

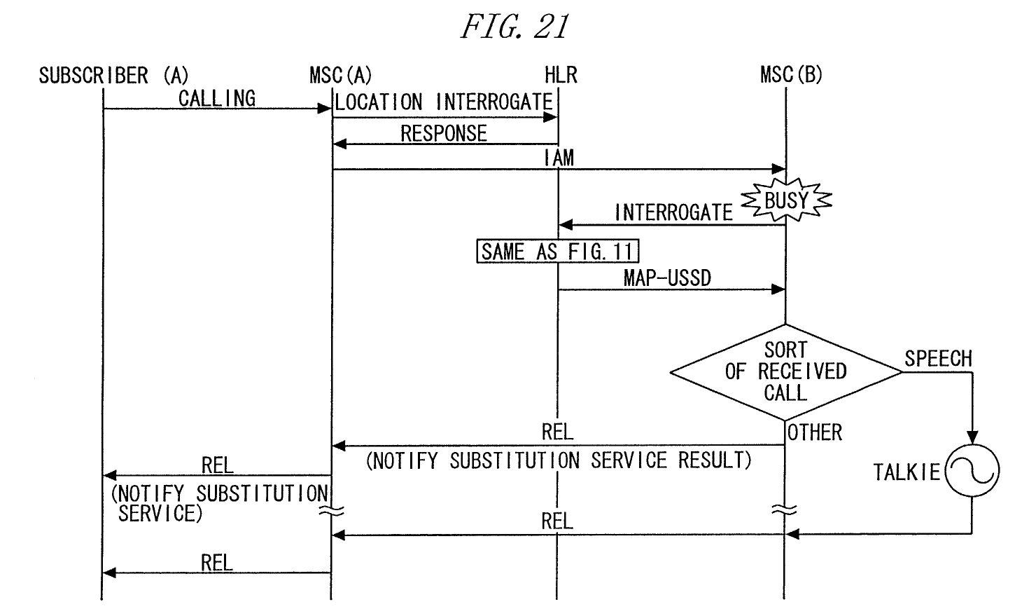

(2) OPERATIONS EXECUTED WHEN THIS SERVICE IS INTERROGATED (SEE FIG. 21):

The service requesting subscriber A sends an originating call to the service providing subscriber B (for instance, subscriber telephone number MSISDN). A mobile switching unit MSC (A) makes a confirmation of a location of the subscriber B from the home location register HLR, and then, relays the originating call by using an IAM message to a mobile switching unit MSC(B) functioning as a connection destination. In such a case that the mobile switching unit MSC (B) which receives the originating call cannot establish the call connection with respect to the subscriber B (for example, this subscriber B is being connected to another service, and is under a busy state), this mobile switching unit MSC (B) interrogates the home location register HLR as to such a service allowable to this subscriber B by using the MAP-USSD protocol.

The home location register HLR returns the service allowable to the subscriber B to the mobile switching unit MSC (B). In response to a sort of called telephone, namely the information representation media (in this case, speech) used when the originating call is received, the mobile switching unit MSC (B) edits a parameter and the like of a communication service allowable to the call-received subscriber B to obtain a REL message, and then, notifies this edited REL message to the subscriber A by way of the talkie apparatus (Talkie).

### FIFTH OPERATION EXAMPLE

In this multimedia information communication system SYS, this service is provided in response to a desired response style of the subscriber A that has executed the communication service interrogation in the above-explained fourth operation example.

(1) OPERATIONS OF SUBSCRIBER (SERVICE PROVIDING SUBSCRIBER) B OF MULTIMEDIA MOBILE COMMUNICATION TERMINAL, THAT SUBSCRIBES TO THIS SERVICE:

This operation is carried out in a similar manner to the above-explained first operation example. It should be noted that as a content to be registered, such a condition may be registered. That is, a communication service is returned in which case.

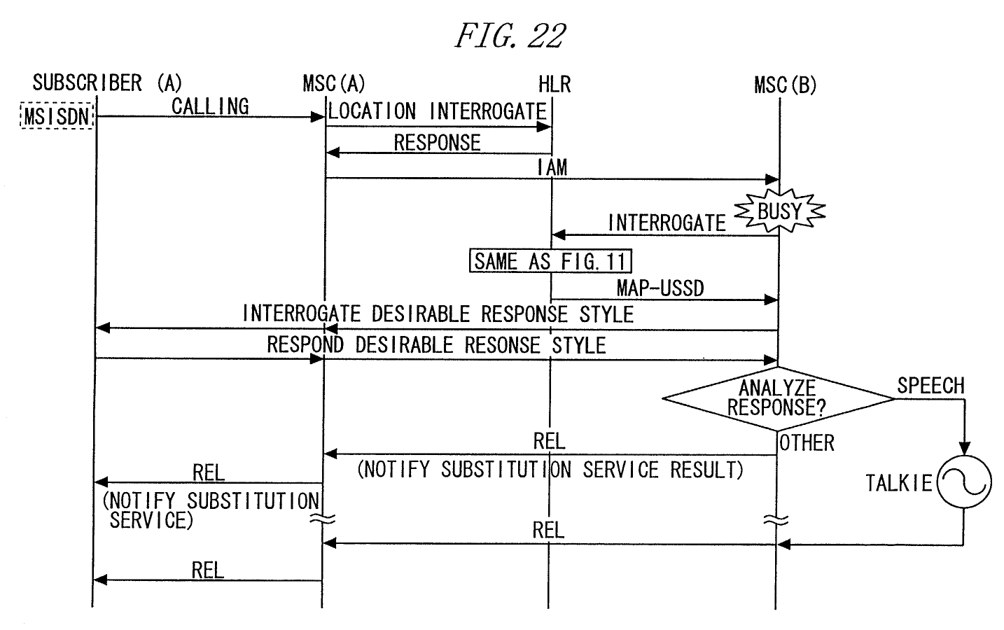

(2) OPERATIONS EXECUTED WHEN THIS SERVICE IS INTERROGATED (SEE FIG. 22):

The subscriber A sends an originating call to the subscriber B (for instance, subscriber telephone number MSISDN). A mobile switching unit MSC(A) makes a confirmation of a location of the subscriber B from the home location register HLR, and then, relays the originating call to a mobile switching unit MSC (B) functioning as a connection destination. In such a case that the mobile switching unit MSC (B) which receives the originating call cannot establish the call connection with respect to the subscriber B (for example, this subscriber B is being connected to another service, and is under a busy state), this mobile switching unit MSC (B) interrogates the home location register HLR as to such a service allowable to this subscriber B by using the MAP-USSD protocol.

The home location register HLR returns the service allowable to the subscriber B to the mobile switching unit MSC (B). The mobile switching unit MSC (B) interrogates the subscriber A via the mobile switching unit MSC (A) as to the desirable response format (desirable response style) of the subscriber A. Then, the mobile switching unit MSC (B) converts/edits this allowable service into this desirable response format, and then, notifies the converted/edited allowable service of the subscriber B to the subscriber A. In this case, since the response format desired by the subscriber A is the speech, the mobile switching unit MSC (B) notifies the communication service by way of the talkie apparatus (Talkie).

### SIXTH OPERATION EXAMPLE

This multimedia information communication system SYS owns plural sorts of communication functions. In this multimedia information communication system SYS, while the multimedia mobile communication terminal (MS), which subscribes to the above-described communication services is operated under an idle condition, such a registering operation can be made that only a specific communication service can be received.

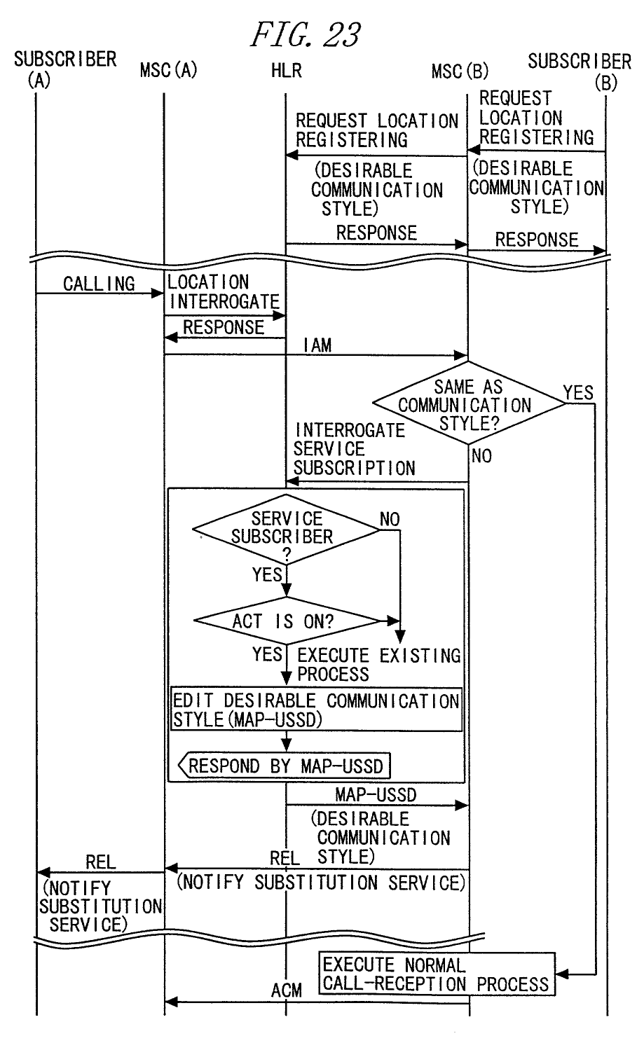

(1) OPERATIONS OF SUBSCRIBER (SERVICE PROVIDING SUBSCRIBER) B OF MULTIMEDIA MOBILE COMMUNICATION TERMINAL, THAT SUBSCRIBES TO THIS SERVICE (SEE FIG. 14 AND FIG. 23):

This operation is basically carried out in a similar manner to the above-explained first operation example. In this sixth operation example, when the existing location of the multimedia mobile communication terminal (MS) is registered, a communication style desired by the subscriber B may be registered. In other words, a desirable communication style registering area is newly added to the existing location registering request message.

(2) OPERATIONS EXECUTED WHEN INTERROGATION OF THIS SERVICE IS ISSUED (SEE FIG. 23):

When the mobile switching unit MSC (B) receives a location register request message from the subscriber B, in such a case that the desirable communication style register area is contained in this request, and furthermore, this subscriber B joins this service, this desirable communication style register area is saved in the subscriber data of the home location register HLR (see FIG. 4c) Upon receipt of the originating call sent from the subscriber A, the mobile switching unit MSC (B) confirms both the subscriber data and the communication style of the home location register HLR, and then, executes the normal called telephone process operation in such a case that the desirable communication style is made coincident with the requested communication style when the originating call is received. To the contrary, when the desirable communication style is not made coincident with the requested communication style, the mobile switching unit MSC (B) returns the desirable communication style by way of the REL message.

### SEVENTH OPERATION EXAMPLE

In the case that this multimedia information communication system SYS responds both the desirable access format and the subscriber identifier thereof, which have been previously registered by the subscriber B in the first operation example, irrespective of an originating call (namely, in response to a request), since a plurality of substitution communication service lists are saved in the auxiliary block 44 of the service bit unit 40 shown in FIG. 4c, this multimedia information communication system SYS may change the substitution communication service list every time the subscriber A requests the service.

(1) OPERATIONS OF SUBSCRIBER (SERVICE PROVIDING SUBSCRIBER) B OF MULTIMEDIA MOBILE COMMUNICATION TERMINAL, THAT SUBSCRIBES TO THIS SERVICE:

This operation is carried out in a similar manner to the above-explained first operation example. However, it should be noted that as a content to be registered, the following content maybe registered. That is, which communication service is returned to a subscriber identifier of an interrogator.

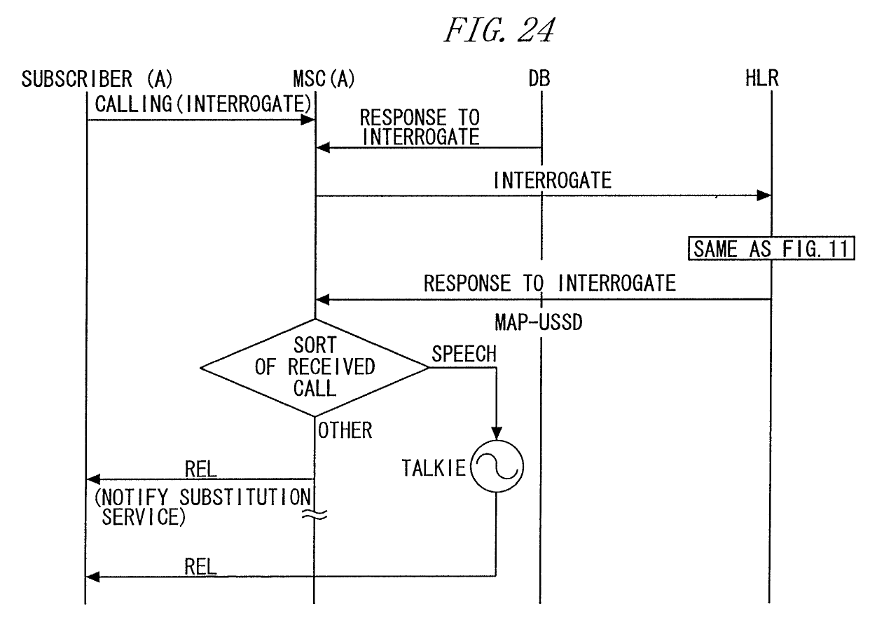

(2) OPERATIONS EXECUTED WHEN PRESENT SERVICE IS INTERROGATED (SEE FIG. 24):

The service requesting subscriber A issues an originating call to a service specific telephone number so as to send a service request. In this case, this subscriber A enters information, for instance, a subscriber telephone number MSISDN of the service providing subscriber B of the communication counter party. When either the mobile switching unit MSC or the home location register HLR functioning as the interrogator cannot be specified based upon the information of the subscriber B, e.g. an electronic mail address, an interrogation message is sent out to the interrogation database DB. The interrogation data base DB returns such a response containing the representative subscriber identifier IMSI.

The mobile switching unit MSC (A) which receives the service request issued from the subscriber A interrogates the home location register HLR as to a service usable by the subscriber B by utilizing the MAP-USSD.

The home location register HLR edits a content in accordance with the received subscriber identifier of the subscriber A, and then, notifies the service allowable to the subscriber B to the mobile switching unit MSC (A) by using the MAP-USSD. The mobile switching unit MSC (A) notifies the service allowable to the subscriber B to the subscriber A.

### EIGHTH OPERATION EXAMPLE

In the case that this multimedia information communication system SYS responds both the desirable access format and the subscriber identifier thereof, which have been previously registered by the service providing subscriber B in the fourth operation example, when this multimedia information communication system SYS cannot be connected to the subscriber B due to a busy state and the like, since a plurality of substitution communication service lists are saved in the auxiliary block 44 of the service bit unit 40 shown in FIG. 4C, this multimedia information communication system SYS may change the substitution communication service list every time the subscriber A requests the service.

(1) OPERATIONS OF SUBSCRIBER (SERVICE PROVIDING SUBSCRIBER) B OF MULTIMEDIA MOBILE COMMUNICATION TERMINAL, THAT SUBSCRIBES TO THIS SERVICE:

This operation is carried out in a similar manner to the above-explained fourth operation example. However, it should be noted that as a content to be registered, the following content maybe registered. That is, which communication service is returned to a subscriber identifier of an interrogator.

(2) OPERATIONS EXECUTED WHEN THIS SERVICE IS INTERROGATED (SEE FIG. 21):

The subscriber A sends an originating call to the service providing subscriber B (for instance, subscriber telephone number MSISDN). A mobile switching unit MSC (A) makes a confirmation of a location of the subscriber B from the home location register HLR, and then, relays the originating call to a mobile switching unit MSC (B) functioning as a connection destination.

In such a case that the mobile switching unit MSC(B) which receives this originating call cannot establish the call connection with respect to the subscriber B (for example, this subscriber B is being connected to another service, and is under a busy state), this mobile switching unit MSC (B) interrogates the home location register HLR as to such a service allowable to this subscriber B by using the MAP-USSD protocol.

The home location register HLR returns the service allowable to the subscriber B to the mobile switching unit MSC (B). In response to a sort of originating calling, namely the information represent media (in this case, speech) used when the originating call is received, the mobile switching unit MSC(B) edits a parameter and the like of a communication service allowable to the call-received subscriber B to obtain a REL message, and then, notifies this edited REL message to the subscriber A by way of the talkie apparatus (Talkie).

### NINTH OPERATION EXAMPLE

In this multimedia information communication system SYS, the network, namely node CN (see FIG. 3) itself may additionally display the priority order (for instance, if packet calls are congested, then connection possibility by speech call is high) with respect to the communication service list.

(1) OPERATIONS OF SUBSCRIBER (SERVICE PROVIDING SUBSCRIBER) B OF MULTIMEDIA MOBILE COMMUNICATION TERMINAL, THAT SUBSCRIBES TO THIS SERVICE:

This operation is carried out in a similar manner to the above-explained first operation example.

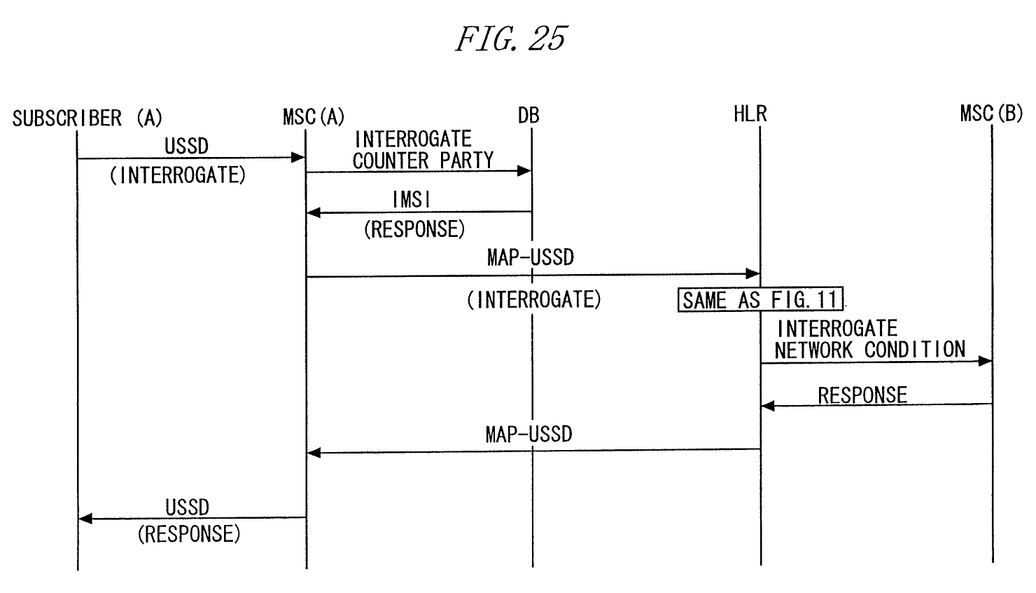

(2) OPERATIONS EXECUTED WHEN THIS SERVICE IS INTERROGATED (SEE FIG. 25):

The service requesting subscriber A issues an originating call to the service specific telephone number so as to request a service. In this case, for example, subscriber telephone number MSISDN is inputted as information of a subscriber B. In such a case that the mobile switching unit MSC, or the interrogated home location register HLR based upon the information of the subscriber B, e.g., an electronic mail address, an interrogation message is sent out to the interrogation database DB. The interrogation database DB returns such a response containing the representative subscriber identifier IMSI.

The mobile switching unit MSC (A) which receives the service request issued from the subscriber A interrogates the home location register HLR as to a service allowable by the subscriber B by utilizing MAP-USSD.

The home location register HLR interrogates the mobile switching unit MSC (B) into which the subscriber B is presently registered as to a network condition by using a new message. In response to this interrogation result, the home location register HLR edits the response content, and then notifies the service allowable to the subscriber B by using the MAP-USSD to the mobile switching unit MSC (A). This mobile switching unit MSC (A) notifies the service allowable to the subscriber B to the subscriber A.

### TENTH OPERATION EXAMPLE

In the above-described fourth operation example, this multimedia information communication system SYS notifies a call reception to the service providing subscriber B, receives an instruction of the subscriber B as a response thereof, and may notify a substitution communication service in accordance with the content of this instruction.

(1) OPERATIONS OF SUBSCRIBER B (SERVICE PROVIDING SUBSCRIBER) OF MULTIMEDIA MOBILE COMMUNICATION TERMINAL, THAT SUBSCRIBES TO THIS SERVICE:

The service providing subscriber B previously determines a button manipulation in a multimedia mobile communication terminal (MS) in order to notify a substitution communication service. In the case that the subscriber identifier MSISDN of the service requesting subscriber A that encounters with a busy state is displayed on the multimedia mobile communication terminal (MS) of the subscriber B, so that when an originating calling condition is notified, the subscriber B notifies the substitution communication service to the mobile switching unit MSC (B) by way of the button manipulation. At this time, the substitution communication service may be cut out, instead of being notified by way of the button manipulation of the subscriber B.

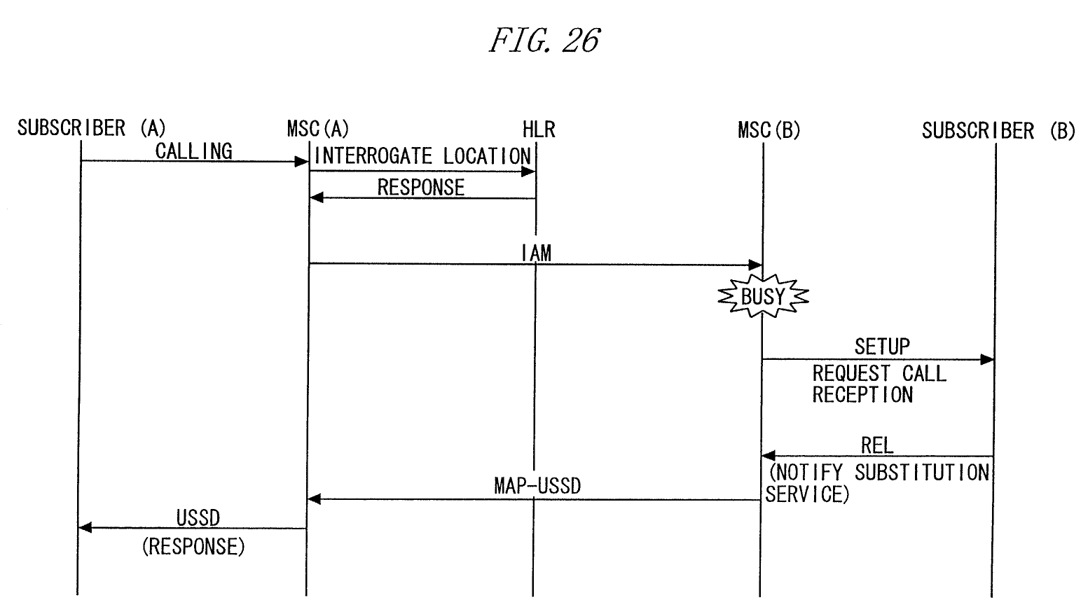

(2) OPERATIONS EXECUTED WHEN THIS SERVICE IS INTERROGATED (SEE FIG. 26):

The subscriber A sends an originating call to the subscriber “B” (for instance, subscriber telephone number MSISDN). A mobile switching unit MSC(A) makes a confirmation of a location of the subscriber B from the home location register HLR, and then, relays the originating call to a mobile switching unit MSC (B) functioning as a connection destination.

Even in such a case that the mobile switching unit MSC (B) which receives this originating call cannot establish the call connection with respect to the subscriber B due to the same reason as to above-described reason, this mobile switching unit MSC (B) executes an originating call process operation in the normal manner. The subscriber B which receives this originating call edits a service equal to a new parameter into the REL message, and then, returns the edited REL message.

The mobile switching unit MSC (B) which receives the REL message containing the new parameter edits an inter-station cutting message in a similar manner, and then, returns the edited inter-station out message to the mobile switching unit MSC (A). The mobile switching unit MSC (A) contains the received message into the cut message without processing this received message, and then notifies the resultant cut message to the subscriber A.

### ELEVENTH OPERATION EXAMPLE

In this multimedia information communication system SYS, when a service is switched to a substitution communication service in the above-described tenth operation example, this multimedia information communication system SYS notifies the service substitution to the service providing subscriber B so as to receive an agreement. Thereafter, the present service may be switched to the substitution communication service.

(1) OPERATIONS OF SUBSCRIBER (SERVICE PROVIDING SUBSCRIBER) B OF MULTIMEDIA MOBILE COMMUNICATION TERMINAL, THAT SUBSCRIBES TO THIS SERVICE:

In the above-explained tenth operation example, when the present service is switched to the substitution communication service, in such a case that the service providing subscriber B receives a switching confirmation message from the mobile switching unit MSC (B), such a response message involving an agreement or disagreement of the service switching is returned to the mobile switching unit MSC(B).

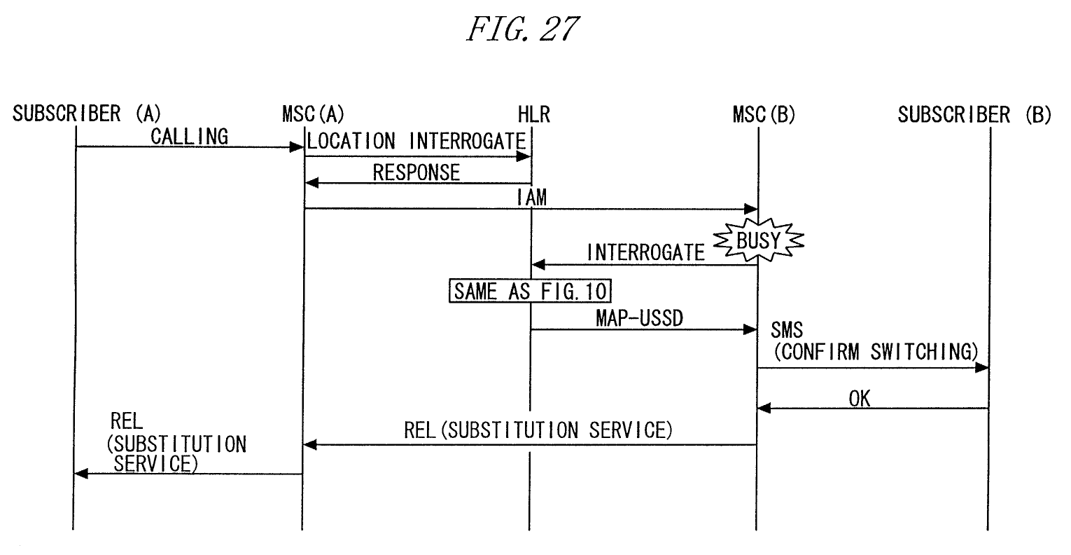

(2) OPERATIONS EXECUTED WHEN THIS SERVICE IS INTERROGATED (SEE FIG. 27):

The service requesting subscriber A sends an originating call to the subscriber B (for instance, subscriber telephone number MSISDN). A mobile switching unit MSC (A) makes a confirmation of a location of the subscriber B from the home location register HLR, and then, relays the originating call to a mobile switching unit MSC (B) functioning as a connection destination.

In such a case that the mobile switching unit MSC (B) which receives this originating call cannot establish the call connection with respect to the subscriber B due to the same reason as the above-explained reason, this mobile switching unit MSC (B) transmits a switching confirmation message (either existing call process message or new message is set) to the subscriber B. In this example, the switching confirmation message is transmitted to the subscriber B by using a sort message service (SMS). The subscriber B that receives this switching confirmation message returns such a response message containing an agreement of switching, or a disagreement of switching to the mobile switching unit MSC (B).

The mobile switching unit MSC (B) edits such an inter-station cut message containing a substitution communication service, and also a subscriber identifier in this case, if necessary, and then, returns the edited inter-station cut message to the mobile switching unit MSC (A). The mobile switching unit MSC (A) again sends the originating call of the subscriber A to the subscriber B in accordance with the substitution communication service.

### TWELFTH OPERATION EXAMPLE

In this multimedia information communication system SYS, since the service providing subscriber B uses a temporarily allocated address as an electronic mail address notified by this service, the service providing subscriber B may select such a secret manner that the own address is not disclosed.

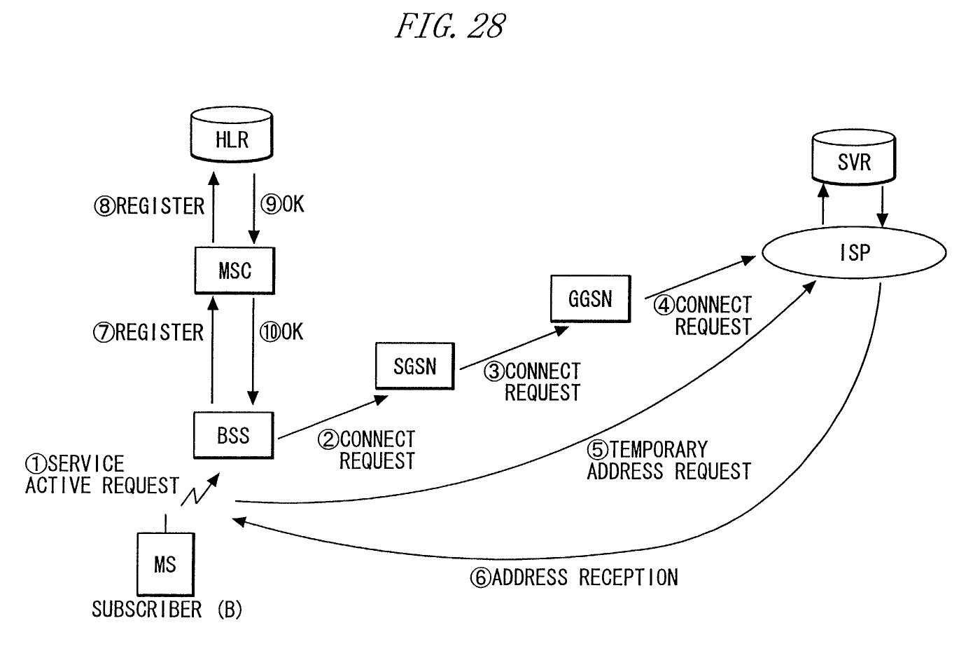

As indicated in FIG. 28, the service providing subscriber B of the multimedia mobile communication terminal (MS) that subscribes to this service is connected to a packet service, and then, requests a temporarily allocated address. After the subscriber B receives the temporarily allocated address which has been transmitted from the Web server SVR, this subscriber B requests the mobile switching unit MSC (B) so as to activate the interrogation service.

Further, in this operation example, in response to the service requesting subscriber A, any one of the normal electronic mail address and the temporarily allocated address may be alternatively selected and responded to.

### MODIFICATION

As a service to which the present invention is applied, the below-mentioned services may be realized. For example, in such a case that a subscriber makes an originating call to a specific counter party by employing a portable telephone terminal equipped with a liquid crystal display unit, in a switching station, another telephone number, an electronic mail address, a facsimile number of this counter party, and the like are retrieved/acquired from a database. Then, this retrieved/acquired item is produced as text data provided with a compact HTML formatted tag, and this text data having the compact HTML text data may be transmitted to the portable telephone terminal owned by the side of the calling subscriber.

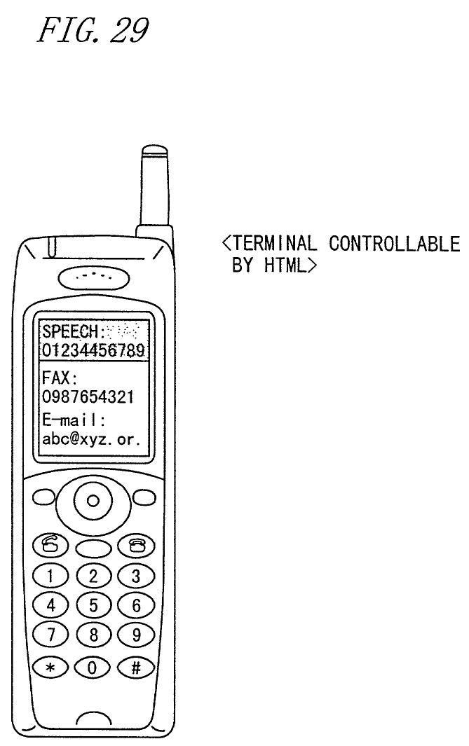

At this time, the telephone number, the electronic mail address, the facsimile number, and the like of the telephone counter party may be displayed on the liquid crystal display unit of the portable telephone terminal on the side of the sender. Since these numbers and the electronic mail address are surrounded by either a tag <phone to> or another tag <mail to>, these numbers are selected by manipulating the operation button of the portable telephone terminal, so that an originating call may be immediately issued to the telephone number of the counter party, or an electronic mail may be immediately transmitted to the electronic mail address of the counter party (see FIG. 29).

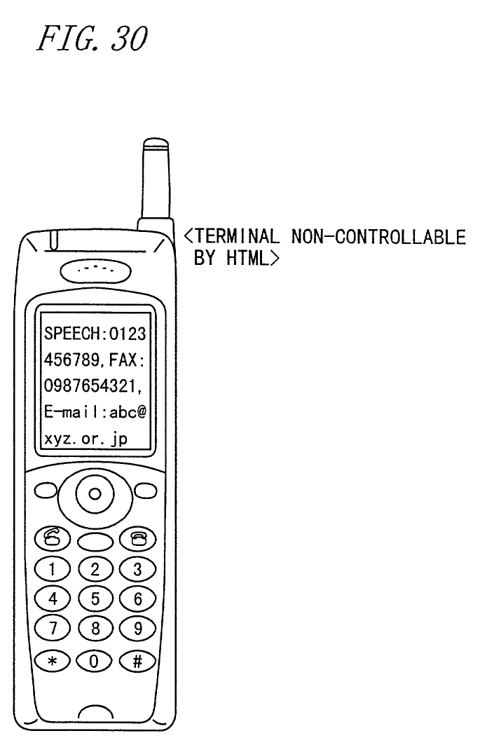

Further, it should also be noted that when such a portable telephone terminal which cannot be HTML-controlled is used, a communication service and a telephone number functioning as a subscriber identifier are displayed in the form of characters on a liquid crystal display unit. In order to send an originating call to a desirable communication service, a telephone number and an electronic mail address may be entered by manipulating an operation button (see FIG. 30).

When the above-described various manners employed in the multimedia information communication system functioning as the communication service information providing system of the present invention are applied to the following various services, the advantages thereof may be highly expected: the Internet connect service such as a WWW access and an electronic mail; an electronic commerce (EC) service such as an electronic bank service; an information service such as an electronic newspaper and an educational information service; a location information service specific to a moving object; an information distribution service such as a tourist guidance to a specific area; a navigation service; and an on-vehicle online shopping service, and so on.

Also, the specific validity of the present invention can be achieved in such a mobile communication system as IMT-2000 (International Mobile Telecommunication System 2000) in which a multimedia terminal may be used in combination with a circuit switching mode bearer and a plurality of bearers contained in a packet switching mode bearer.

Although only a few embodiments of the present invention have been described in detail above, those skilled in the art will readily appreciate that many modifications are possible in the preferred embodiments without departing from the novel teachings and advantages of the present invention. Accordingly, all such modifications are intended to be included within the scope of the present invention as defined by the following claims.

What is claimed is:

1. A communication service information providing method comprising the steps of:
receiving a call used to select one of plural communication services, which is transmitted from a calling subscriber to a called subscriber that subscribes the plurality of communication services; and
providing information related to another communication service subscribed to by the called subscriber with respect to the calling subscriber.

2. A communication service information providing method comprising the steps of:
receiving a call used to select one of plural communication services, which is transmitted from a calling subscriber to a called subscriber that subscribes the plurality of communication services;
providing information related to another communication service subscribed to by the called subscriber with respect to the calling subscriber; and
when the calling subscriber selects one of other communication services from the provided information, trying to connect to the called subscriber by way of the selected another communication service.

3. A communication service information providing method comprising the steps of:
receiving a call issued from a calling subscriber that selects a voice communication to a called subscriber, while utilizing a communication terminal equipped with a display unit;
acquiring communication identification information from a database related to the called subscriber in a switching apparatus which accepts the call, the communication identification information being any one of a telephone number, an electronic mail address, and a facsimile number of communication services which are subscribed to by the called subscriber; and
displaying the acquired communication identification information on the display unit of the communication terminal owned by the calling subscriber under a selectable condition.

4. A communication service information providing method comprising the steps of:
storing both a plurality of communication services which are subscribed to by a subscriber and are made of plural sorts of information representation media, and identification information capable of selectively utilizing the communication services so as to establish a communication; and
notifying both the communication service subscribed to by a subscriber that wants to establish a communication, and the identification information corresponding to the communication service to a calling terminal in response to a request issued from the calling terminal.

5. A communication service information providing method comprising the steps of:
storing both a plurality of communication services which are subscribed to by a subscriber and are made of plural sorts of information representation media, and identification information capable of selectively utilizing the communication services so as to establish a communication; and
notifying both the communication service subscribed to by a subscriber that wants to establish a communication, and the identification information corresponding to the communication service to a calling terminal when the calling terminal encounters with a communication non-connectable state.

6. A communication service information providing method as claimed in claim 4, further comprising the step of:
notifying to the calling terminal, both the communication service and the identification information corresponding to the communication service, in the form of an allowable mode which is previously registered by the subscriber to which wants to establish the communication.

7. A communication service information providing method as claimed in claim 4, further comprising the step of:
notifying to the calling terminal, both the communication service and the identification information corresponding to the communication service subscribed to by the subscriber that wants to establish the communication by way of the information representation media requested by the calling terminal.

8. A communication service information providing method as claimed in claim 4, further comprising the step of:
notifying to the calling terminal, both the communication service and the identification information corresponding to the communication service subscribed to by the subscriber that wants to establish the communication by way of the information representation media which is used to issue the call by the calling terminal.

9. A communication service information providing method as claimed in claim 4, further comprising the step of:
changing both the communication service and the identification information corresponding to the communication service, in the form of an allowable mode which is previously registered by the subscriber to which wants to establish the communication, in accordance with the calling terminal, and for notifying the changed communication service and the changed identification information.

10. A communication service providing method as claimed in claim 5, further comprising the step of:
notifying an occurrence of a call reception to the subscriber that wants to establish the communication, and for notifying to the calling terminal, a substitution of both the communication service and the identification information corresponding to the communication service in accordance with a content of a response.

11. A communication service information providing method as claimed in claim 10, further comprising the step of:
changing the selected communication service to the substitution of both the communication service and the identification information corresponding to the communication service, after agreeing by the subscriber that wants to establish the communication.

12. A communication service information providing method comprising the steps of:
storing both a plurality of communication services which are subscribed to by a subscriber and are made of plural sorts of information representation media, and identification information by which the communication services can be selectively used to establish a communication; and
selecting both the communication service subscribed to by a subscriber that wants to establish a communication, and the identification information corresponding to the communication service, to which a calling terminal is communication-connectable in response to the communication condition of the information representation media, and for notifying the selected communication service and the selected identification information to the calling terminal.

13. A communication service information providing method as claimed in claim 4, further comprising the step of:
notifying the identification information which is temporarily allocated to the calling terminal.

14. A communication service information providing method as claimed in claim 4, further comprising the step of:
selectively notifying one of the identification information which is temporarily allocated, and the identification information under normal condition in response to the calling terminal.

15. A communication network comprising:
reception means for receiving a call used to select one of plural communication services from a calling terminal with respect to a subscriber of a communication counter party that wants to establish a communication and subscribes the plurality of communication services; and
providing means for providing information related to another communication service subscribed to by the subscriber of the communication counter party that wants to establish the communication with respect to the calling terminal.

16. A communication network comprising:
reception means for receiving a call used to select one of plural communication services from a calling terminal with respect to a subscriber of a communication counter party that wants to establish a communication and subscribes the plurality of communication services;
providing means for providing information related to another communication service subscribed to by the subscriber of the communication counter party that wants to establish the communication with respect to the calling terminal; and
connection means in which when the calling terminal selects one of other communication services from the provided information, the connection means tries to connect with the subscriber of the communication counter party that wants to establish the communication by using the selected another communication service.

17. A communication network comprising:
reception means for receiving a call issued to a subscriber of a communication counter party that wants to establish a communication from a communication terminal which equipped with a display unit and selected a voice communication;
acquisition means for acquiring communication identification information in a switching apparatus which accepts the call from a database related to the subscriber of the communication-desired counter party, the communication identification information being any one of a telephone number, an electronic mail address, and a facsimile number, which correspond to the subscriber of the communication-desired counter party; and
display process means for displaying the acquired communication identification information on the display unit of the communication terminal under a selectable condition.

18. A communication network comprising:
storage means for storing both a plurality of communication services which are subscribed to by a subscriber and are made of plural sorts of information representation media, and identification information capable of selectively utilizing the communication services so as to establish a communication; and
notification means for notifying both the communication service subscribed to by a subscriber that wants to establish a communication, and the identification information corresponding to the communication service to a calling terminal in response to a request issued from the calling terminal.

19. A communication network comprising:
storage means for storing both a plurality of communication services which are subscribed to by a subscriber and are made of plural sorts of information representation media, and identification information capable of selectively utilizing the communication services so as to establish a communication; and
notification means for notifying both the communication service subscribed to by a subscriber that wants to establish a communication, and the identification information corresponding to the communication service to a calling terminal when the calling terminal encounters with a communication non-connectable state.

20. A communication network comprising:
storage means for storing both a plurality of communication services which are subscribed to by a subscriber and are made of plural sorts of information representation media, and identification information by which the communication services can be selectively used to establish a communication; and
notification means for selecting both the communication service subscribed to by a subscriber that wants to establish a communication, and the identification information corresponding to the communication service, to which a calling terminal is communication-connectable in response to the communication condition of the information representation media, and for notifying the selected communication service and the selected identification information to the calling terminal.
